(19) United States
(12) Patent Application Publication
(10) Pub. No.: US 2024/0336352 A1
(43) Pub. Date: Oct. 10, 2024

(54) SYSTEMS AND METHODS FOR AIRCRAFT TAIL STRIKE PREVENTION

(71) Applicant: ZSM HOLDINGS, LLC, Dover, DE (US)

(72) Inventors: Blake Poe, Longmont, CO (US); Jason C. Bell, Frederick, CO (US); Mathew James Isler, Sammamish, WA (US)

(21) Appl. No.: 18/294,537

(22) PCT Filed: Aug. 3, 2022
(86) PCT No.: PCT/US2022/039351

§ 371 Date: Feb. 1, 2024

Related U.S. Application Data
(60) Provisional application No. 63/229,046, filed on Aug. 3, 2021.

(51) Int. Cl. B64C 25/00

(52) U.S. Cl. CPC B64C 25/001; B64C 2025/005

(57) ABSTRACT

Tail strike mitigation devices and related methods are disclosed herein that can prevent or mitigate a tail of an aircraft from striking a runway surface when landing or taking off, including when landing on or taking off from a semi-prepared runway. Tail strike mitigation devices of the present disclosure can extend, for example, from a bottom surface of the fuselage of the aircraft at a tail of an aircraft and/or can include a tail skid with a large contact surface area, as compared to conventional tail strike devices. The tail skid can have a high flotation impact surface. The tail skid can be moved between retracted and deployed positions, and can be oriented at a range of angle relative to at least one of the landing surface and/or the bottom surface of the fuselage.

### CROSS-REFERENCE TO RELATED APPLICATIONS

This application claims priority to and the benefit of U.S. Provisional Patent Application Ser. No. 63/229,046, entitled “SYSTEMS AND METHODS FOR AIRCRAFT TAIL STRIKE PREVENTION,” and filed Aug. 3, 2021, the contents of which is incorporated by reference herein in its entirety.

### FIELD

The present disclosure relates to various ways by which a tail portion of an aircraft can be protected from striking ground during takeoff and/or landing, and more particularly, in at least one instance, provides for a tail skid specially designed to allow its pitch angle to be selectively controlled, for example to allow the tail skid to be substantially parallel to a ground surface on which the aircraft is landing.

### BACKGROUND

During the operational lifetime of an aircraft, it is possible for the aircraft to experience a tail strike during takeoff and/or landing upon rotation of the aircraft beyond a threshold degree. Although tail strike occurrences are rare, it can be desirable to take measures to mitigate the impact to a fuselage of the aircraft, and even prevent such an impact, throughout the continued operation of the aircraft. A single tail strike can cause significant damage to the aircraft that is either costly to repair and/or may require the aircraft to be taken out of commission. The bigger and more expensive the aircraft is, the bigger issue a tail strike can be on the overall impact to the owner and/or user of the aircraft. Further, as certain aircrafts are designed to be bigger and/or have larger tail regions, that may result in in a tail strike being a more likely occurrence.

Commercial airplanes can include a small skid plate that can serve as a tail skid device. The small skid plate can exert extremely high pressure upon a runway in the case of a tail strike impact. Commercial aircraft are designed and required to land on fully prepared runways at developed airports. A fully prepared, e.g., fully paved, runway can absorb the pressure exerted by the small skid plate of a conventional tail skid device, allowing the skid plate to function as intended and skim or skid across the runway.

Compared to typical commercial runways, semi-prepared runways, e.g., gravel runways or runways that are not fully paved, have a significantly lower bearing capacity. In other words, the surface and material of a semi-prepared runway is softer than pavement. On such a runway, the high pressure exerted by a conventional small skid plate upon occurrence of a tail strike typically ruts the skid plate deep into the runway. This not only reduces the effectiveness of the tail skid device, but also imparts unpredictable loads upon the supporting airframe structure, thus risk causing serious and unpredictable damage. Moreover, such an impact may cause considerable damage to the runway due to the skid plate gouging the runway surface.

Accordingly, there is a need for a tail skid device, or tail strike protection devices and methods more generally, that can effectively mitigate a tail strike occurrence on ground, such as a semi-prepared runway, without imparting unpredictable loads upon an aircraft frame.

### SUMMARY

Certain aspects of the present disclosure provide methods and devices that mitigate or entirely prevent a tail of an aircraft from striking a runway surface during a takeoff or landing maneuver. Method and devices for preventing damage to particular runways, for example semi-prepared runways, are provided for herein. Examples of the present disclosure include extremely large cargo aircraft capable of both carrying extremely long payloads and being able to take off and land at runways that are significantly shorter than those required by most, if not all, existing large aircraft. For purposes of the present disclosure, a large or long aircraft is considered an aircraft having a fuselage length from fuselage nose tip to fuselage tail tip that is at least approximately 60 meters long. The American Federal Aviation Administration (FAA) defines a large aircraft as any aircraft of more than 12,500 pounds maximum certificated takeoff weight, which can also be considered a large aircraft in the present context, but the focus of size is generally related to a length of the aircraft herein. One example of such an oversized payload capable of being transported using examples of this present disclosure are wind turbine blades, the largest of which can be over 100 meters in length. Examples of the present disclosure enable a payload of such an extreme length to be transported within the cargo bay of an aircraft having a fuselage length only slighter longer than the payload, while that aircraft can also take off and land at most existing commercial airports, as well as runways that are even smaller, for instance because they are built at a desired location for landing such cargo aircraft near a site where the cargo is to be used, such as a landing strip built near or as part of a wind farm. These can include semi-prepared runways.

The tail strike devices of the present disclosure can: (1) reduce the overall force during a trail strike incident; (2) absorb the load in a predictable manor, (3) avoid damaging the semi-prepared runway as much as possible, and (4) provide an indicator of the severity and/or magnitude of an impact after it occurs. Tail strike devices of the present disclosure can include a tail skid or semi-prepared runway operations (SPRO) board that can contact a runway or landing surface with a significantly larger impact surface than conventional tail strike devices in instances in which an aircraft exceeds a threshold degree of rotation and/or rotational velocity. Further, SPRO boards of the present disclosure can be or have a high flotation impact surface that can reduce a total pressure imparted by the tail strike device onto a runway. As such, tail strike devices disclosed herein can effectively reduce and/or eliminate damage to an aircraft and to the runway during a takeoff or landing on the runway, including semi-prepared runways. By way of non-limiting example, a semi-prepared runway can have a landing surface that includes, at least in part, packed gravel, native soil, cement stabilized native soil, metal runway mats, geotechnical stabilizing meshes, etc. Still further, as described herein, SPRO boards, and their related components, can be designed to be controlled to achieve desired pitch angles. For example, a controller can be operated to maneuver a pitch angle of the SPRO board to be substantially parallel to the ground surface on which the aircraft is landing. In at least some embodiments, the SPRO board can be deployed from a stowed configuration, in which it is disposed within and/or in contact with and/or near the fuselage, and a deployed configuration in which it is disposed at a desired pitch angle for a takeoff or landing operation.

One embodiment or a tail strike mitigation system for an aircraft includes a tail skid and a retraction system. The tail skid has an upper surface and a lower surface, with the lower surface being configured to contact a landing surface to prevent a fuselage of an aircraft from striking the landing surface. The retraction system is configured to couple the tail skid to an aft end of the fuselage of the aircraft located rearward of a landing gear of the aircraft. The tail skid is sized such that a maximum pressure exerted by the tail skid on a landing surface is equal to or less than a pressure exerted by the landing gear of the aircraft on a landing surface in a case of maximum vertical load on the landing gear. Further, the tail skid is also sized so as to maximize distribution of a force imparted on the tail skid by the landing surface throughout the tail skid in an event of the tail skid contacting the landing surface.

The retraction system can include a first linkage, a second linkage, and an upper retraction assembly. The first linkage can be coupled to the tail skid at a first location and the second linkage can be coupled to the tail skid at a second location, spaced apart from the first location. The upper retraction assembly can be coupled to the tail skid, retained at least partially within the fuselage. The upper retraction assembly can be configured to move the tail skid relative to the fuselage. Further, the upper retraction assembly can include a first linkage assembly and a second linkage assembly coupled to the first linkage assembly. The first linkage can be coupled to the fuselage and the second linkage assembly can be coupled to the tail skid.

In at least some embodiments, the retraction system can further include an actuator coupled to the first linkage assembly. The actuator can be configured to pull the first linkage assembly in a direction at least partially away from the bottom surface of the aft end of the fuselage to move the tail skid to the retracted position. The actuator can be further configured to push the first linkage assembly in a direction at least partially toward the bottom surface to move the tail skid to the deployed position.

The second linkage assembly can include a compressible member configured to compress linearly along a longitudinal axis of the compressible member from forces imparted on the tail skid upon contact with the landing surface. An amount of compression of the compressible member can be configured to correlate to a magnitude of impact of the tail skid and the landing surface.

The tail skid can be configured to be movable between a retracted position and a deployed position via the upper retraction assembly. In the deployed position, the tail skid can be at a fixed location at a first distance from a bottom surface of the aft end of the fuselage at which the tail skid is configured to prevent the fuselage from contacting the landing surface in response to an attitude of the aircraft being equal to or exceeding a tail strike attitude at which the aft end will strike the landing surface. The deployed position can include a plurality of positions achievable by the tail skid. The plurality of positions can have different pitch angles at which the tail skid can be positioned with respect to at least one of the landing surface or the fuselage and/or different roll angles at which the tail skid can be positioned with respect to at least one of the landing surface or the fuselage. In the retracted position, the tail skid can be located a second distance from a bottom surface of the aft end of the fuselage less than the first distance. In the retracted position, the tail skid can contact the bottom surface of the aft end of the fuselage.

The tail skid can be configured to couple to the aft end of the fuselage of the aircraft at a location substantially underneath horizontal stabilizers of an empennage of the aircraft. A surface area of the lower surface of the tail skid can be approximately 0.1 square meters or larger. In some embodiments, the surface area of the lower surface of the tail ski can be approximately 0.29 square meters or larger. In some embodiments, the surface area of the lower surface of the tail skid can be approximately in the range of about 0.1 square meters to about 1.0 square meters. In some embodiments, the surface area of the lower surface of the tail skid can be approximately in the range of about 0.29 square meters to about 1.0 square meters. In some embodiments, the lower surface of the tail skid can have a generally rectangular shape, and in these or other embodiments, the tail skid can include one or more curved edges that extend upwardly away from the lower surface. The tail skid can include a composite sandwich panel. A core material of the composite sandwich panel can be formed of at least one of a honeycomb material, a wood material, or a foam material. Opposed face sheets can be disposed on either side of the fore material and can be formed of at least one of a fiberglass material, an aramid material, or a carbon fiber material.

A controller can be configured to adjust at least one of the pitch angle of the tail skid or the roll angle of the tail skid during at least one of a takeoff operation or a landing operation to allow for the plurality of deployed, fixed positions. The controller can be configured to receive one or more data inputs and adjust at least one of the pitch angle or the roll angle in response to the same. The controller can be configured to adjust at least one of the pitch angle or the roll angle automatically in response to the one or more received data inputs.

One exemplary tail strike mitigation system for an aircraft includes a tail skid and a retraction system. The tail skid includes a lower surface configured to contact a landing surface to prevent a fuselage of an aircraft from striking the landing surface. The retraction system is configured to couple the tail skid to the fuselage of the aircraft. The linkage system includes at least one adjustable actuating device configured to be able to adjust at least one of a pitch angle of the tail skid relative to at least one of the landing surface or the fuselage or a roll angle of the tail skid relative to at least one of the landing surface or the fuselage. In particular, the actuating device adjusts the pitch angle of the tail skid relative to at least one of the landing surface or the fuselage to a desired first pitch angle such that a predetermined surface area of the lower surface of the tail skid is positioned to contact the landing surface at a desired pitch angle in an event of the tail skid contacting the landing surface. Further, the actuating device adjusts the roll angle of the tail skid relative to at least one of the landing surface or the fuselage to a desired first roll angle such that a predetermined surface area of the lower surface of the tail skid is positioned to contact the landing surface at a desired roll angle in an event of the tail skid contacting the landing surface.

The retraction system can further include a first linkage, a second linkage, and an upper retraction assembly. The first linkage can be coupled to the tail skid at a first location, and the second linkage can be coupled to the tail skid at a second location spaced apart from the first location. The upper retraction assembly can be coupled to the tail skid, retained at least partially within the fuselage and configured to move the tail skid relative to the fuselage.

In some embodiments, the tail skid can be configured to be movable between a retracted position and a deployed position via the upper retraction assembly. The deployed position can include one or more fixed locations at which the tail skid is configured to be prevent the fuselage from contacting the landing surface in response to an attitude of the aircraft being equal to or exceeding a tail strike attitude at which the aft end will strike the landing surface. The deployed position can include a plurality of fixed locations at which the tail skid is configured to be prevent the fuselage from contacting the landing surface in response to an attitude of the aircraft being equal to or exceeding a tail strike attitude at which the aft end will strike the landing surface.

The tail skid can define a tail skid plane and a bottom surface of the aft end of the fuselage can define an aft fuselage plane. The upper retraction assembly can be configured to rotate the tail skid relative to the aft end of the fuselage. Moreover, at least one of: (i) a second pitch angle can be defined between the tail skid plane and the aft fuselage plane and the first pitch angle can be defined between the tail skid plane and the landing surface plane; or (ii) a second roll angle can be defined between the tail skid plane and the aft fuselage plane and the first roll angle can be defined between the tail skid plane and the landing surface plane.

The retraction assembly can be configured to rotate the tail skid such that the tail skid plane is substantially parallel with the aft fuselage plane. In some embodiments, the retraction assembly can be configured to rotate the tail skid such that the tail skid plane is substantially parallel with the landing surface plane in response to the aircraft being oriented at a level attitude relative to a horizon. In some embodiments, the retraction assembly can be configured to rotate the tail skid such that the tail skid plane is substantially parallel with the landing surface plane in response to the aircraft being oriented at a first attitude relative to a horizon.

In some embodiments, the upper retraction assembly can be configured to rotate the tail skid such that the first pitch angle and/or the second pitch angle is approximately in a range of about 0 degrees to about 25 degrees. In the deployed position, the tail skid can be at a fixed location a first distance from a bottom surface of the aft end of the fuselage at which the tail skid is configured to prevent the fuselage from contacting the landing surface in response to an attitude of the aircraft being one of equal to or exceeding a tail strike attitude at which the aft end will strike the landing surface. In the retracted position, the tail skid can be located a second distance from a bottom surface of the aft end of the fuselage less than the first distance, and, in the retracted position, the tail skid can contact the bottom surface of the aft end of the fuselage.

The tail skid can be configured to couple to the aft end of the fuselage of the aircraft at a location substantially underneath horizontal stabilizers of an empennage of the aircraft. The lower surface of the tail skid can be a generally planar lower surface portion surrounded by curved edges that extend upwardly away from the lower surface portion. A surface area of the lower surface of the tail skid can be approximately 0.1 square meters or larger. In some embodiments, the surface area of the lower surface of the tail ski can be approximately 0.29 square meters or larger. In some embodiments, the surface area of the lower surface of the tail skid can be approximately in the range of about 0.1 square meters to about 1.0 square meters. In some embodiments, the surface area of the lower surface of the tail skid can be approximately in the range of about 0.29 square meters to about 1.0 square meters.

In some embodiments, the lower surface of the tail skid can have a generally rectangular shape. The tail skid can include one or more curved edges that extend upwardly away from the lower surface. In some embodiments, the tail skid can include an upper layer defining the upper surface and a lower layer arranged underneath the upper layer and defining the lower surface. The upper layer can be formed of at least one of a honeycomb material, a wood material, or a foam material, and the lower layer can be formed of a composite material.

A controller can be configured to adjust at least one of the pitch angle of the tail skid or the roll angle of the tail skid during at least one of a takeoff operation or a landing operation. The controller can be configured to receive one or more data inputs and adjust at least one of the pitch angle or the roll angle in response to the same. The controller can be configured to adjust at least one of the pitch angle or the roll angle automatically in response to the one or more received data inputs.

One method of one landing an aircraft on a landing surface or taking an aircraft off from a landing surface includes adjusting at least one of a pitch angle of a tail skid of an aircraft or a roll angle of a tail skid of an aircraft relative to at least one of a landing surface or a fuselage to a respective first pitch angle or first roll angle. This is done as the aircraft one of: (1) approaches the landing surface to land; or (2) readies to leave the landing surface to takeoff. The tail skid is adjustably coupled to an aft end of the aircraft and is located rearward of a landing gear of the aircraft. Further, the respective first pitch angle or first roll angle is an angle at which a predetermined surface area of a lower surface of the tail skid is configured to possibly contact the landing surface during respective landing or takeoff.

In some embodiments, the method can further including moving the tail skid from a retracted position to a deployed position. In the deployed position, the tail skid can be located at a fixed location at a first distance from a bottom surface of the aft end of the fuselage. The fixed location can be one at which the tail skid is configured to prevent the fuselage from contacting the landing surface in response to an attitude of the aircraft being equal to or exceeding a tail strike attitude at which the aft end will strike the landing surface. In at least some embodiments, the deployed position can include a plurality of positions achievable by the tail skid. The plurality of positions can have different pitch angles and/or different roll angles at which the tail skid can be positioned with respect to at least one of the landing surface or the fuselage. In the retracted position, the tail skid can be located a second distance from a bottom surface of the aft end of the fuselage less than the first distance.

The tail skid can include an upper surface and a lower surface, with the lower surface being configured to contact a landing surface to prevent a fuselage of the aircraft from striking the landing surface. The tail skid can define a tail skid plane and a bottom surface of the aft end of the fuselage can define an aft fuselage plane. Further, the landing surface can define a landing surface plane. A second pitch angle and/or a second roll angle can be defined between the tail skid plane and the aft fuselage plane and the respective first pitch angle and/or first roll angle can be defined between the tail skid plane and the landing surface plane. In at least some such embodiments, the method can further include rotating the tail skid relative to the aft end of the fuselage. The method can also include rotating the tail skid such that the tail skid plane is substantially parallel with the aft fuselage plane and/or such that the tail skid plane is substantially parallel with the landing surface plane in response to the aircraft being oriented at a level attitude relative to a horizon. The method can further include rotating the tail skid such that the tail skid plane is substantially parallel with the landing surface plane in response to the aircraft being oriented at a first attitude relative to a horizon.

The tail skid can be rotated such that one or more of the first pitch angle, the second pitch angle, the first roll angle, and/or the second roll angle can be approximately in a range of about 0 degrees to about 25 degrees. In some embodiments, the method can include rotating the tail skid such that a forward end of the tail skid is higher than an aft end of the tail skid relative to the landing surface during landing of the aircraft.

A method of one of landing an aircraft on a semi-prepared runway or taking an aircraft off from a semi-prepared runway includes causing a tail strike device coupled to an aft end of an aircraft located rearward of a landing gear of the aircraft to contact an upper landing surface of a semi-prepared runway to prevent a fuselage of the aircraft from contacting the upper landing surface of the semi-prepared runway. This occurs while one of: (1) landing the aircraft; or (2) operating the aircraft to takeoff. The semi-prepared runway includes a runway base layer beneath the upper landing surface. Further, throughout the respective landing or takeoff, the tail strike device skims along the semi-prepared runway without penetrating past the upper landing surface and into the runway base layer.

The tail skid can include an upper surface and a lower surface. The lower surface can be configured to contact the landing surface to prevent the fuselage of the aircraft from contacting the upper landing surface while the respective landing or takeoff of the aircraft. Additionally, or alternatively, tail skid can be sized such that a maximum pressure exerted by the tail skid on the upper landing surface permits the tail skid along the upper landing surface while the respective landing or takeoff of the aircraft.

The method can further include moving the tail skid from a retracted position to a deployed position. In the deployed position, the tail skid can be located at a fixed location at a first distance from a bottom surface of the aft end of the fuselage. The fixed location can be one at which the tail skid is configured to prevent the fuselage from contacting the landing surface in response to an attitude of the aircraft being to or exceeding a tail strike attitude at which the aft end will strike the landing surface. The deployed position can include a plurality of positions that are achievable by the tail skid. The plurality of positions can have different pitch angles at which the tail skid is positioned with respect to at least one of the landing surface or the fuselage and/or different roll angles at which the tail skid is positioned with respect to at least one of the landing surface or the fuselage. In the retracted position, the tail skid can be located a second distance from a bottom surface of the aft end of the fuselage less than the first distance.

The tail skid can define a tail skid plane and a bottom surface of the aft end of the fuselage can define an aft fuselage plane. Further, the landing surface can define a landing surface plane. A second pitch angle and/or a second roll angle can be defined between the tail skid plane and the aft fuselage plane and the respective first pitch angle and/or first roll angle can be defined between the tail skid plane and the landing surface plane. In at least some such embodiments, the method can further include rotating the tail skid relative to the aft end of the fuselage. The method can also include rotating the tail skid such that the tail skid plane is substantially parallel with the aft fuselage plane and/or such that the tail skid plane is substantially parallel with the landing surface plane in response to the aircraft being oriented at a level attitude relative to a horizon. The method can further include rotating the tail skid such that the tail skid plane is substantially parallel with the landing surface plane in response to the aircraft being oriented at a first attitude relative to a horizon.

The tail skid can be rotated such that the first pitch angle and/or the second pitch angle is approximately in a range of about 0 degrees to about 25 degrees. In some embodiments, the method can further include rotating the tail skid such that a forward end of the tail skid is higher than an aft end of the tail skid relative to the landing surface during landing of the aircraft.

### BRIEF DESCRIPTION OF DRAWINGS

This disclosure will be more fully understood from the following detailed description taken in conjunction with the accompanying drawings, in which:

FIG. 1A is an isometric view of one exemplary embodiment of an aircraft;

FIG. 1B is a side view of the aircraft of FIG. 1A;

FIG. 2 is an isometric view of the aircraft of FIG. 1A with a nose cone door in an open position to provide access to an interior cargo bay of the aircraft;

FIG. 3 is a schematic side view of an aircraft in the prior art, illustrating a lateral axis of rotation with respect to tail strike;

FIG. 4 is a side view of an alternative exemplary embodiment of an aircraft;

FIG. 5 is a side view of the aircraft of FIG. 4 in a takeoff position;

FIG. 6 is the side cross-sectional view of the aircraft of FIG. 1A with an exemplary payload disposed in the interior cargo bay;

FIG. 7 is a side view of the aircraft of FIG. 1B with a tail strike device proximate to the tail of the aircraft according to the present disclosure;

FIG. 8A is a side view of the aircraft of FIG. 7, showing the frame of the fuselage of the aircraft;

FIG. 8B is an enlarged side view of the aircraft of FIG. 7, showing the aft end of the fuselage of the aircraft;

FIG. 9 is an enlarged view of the tail section of the aft end of the aircraft of FIG. 8B, showing two frame portions on which the tail strike device is mounted;

FIG. 10 is a schematic view of the aft end and the tail strike device of FIG. 9, showing a moment arm of the aircraft;

FIG. 11 is a side perspective view of the tail strike device of FIG. 7, showing that the tail strike device includes a tail skid and a retraction system;

FIG. 12 is a top perspective view of the tail strike device of FIG. 7;

FIG. 13 is a perspective view of the tail strike device of FIG. 7;

FIG. 14 is a perspective view of the tail skid of the tail strike device of FIG. 7;

FIG. 15 is a perspective view of the tail skid of FIG. 14, showing that the skid can include stiffeners;

FIG. 16A is a front perspective view of the tail skid of FIG. 14;

FIG. 16B is a bottom perspective view of the tail skid of FIG. 14;

FIG. 17 is a top view of the tail skid of FIG. 14;

FIG. 18 is a front view of the tail skid of FIG. 14;

FIG. 19A is an enlarged perspective view of the tail strike device of FIG. 7;

FIG. 19B is an enlarged perspective view of the tail strike device of FIG. 7;

FIG. 20A is an enlarged side perspective view of the tail strike device of FIG. 7 in a deployed position;

FIG. 20B is an enlarged side view of the tail strike device of FIG. 20A in the deployed position;

FIG. 20C is an enlarged side view of the tail strike device of FIG. 20A in a position between the deployed position and the retracted position shown in FIGS. 21A and 21B;

FIG. 20D is an enlarged side view of the tail strike device of FIG. 20A in a position between the deployed position and the retracted position shown in FIGS. 21A and 21B;

FIG. 20E is an enlarged side view of the tail strike device of FIG. 20A in a position between the deployed position and the retracted position shown in FIGS. 21A and 21B;

FIG. 21A is an enlarged side perspective view of the tail strike device of FIG. 7 in a retracted position;

FIG. 21B is an enlarged side view of the tail strike device of FIG. 21A in the retracted position;

FIG. 21C is an enlarged side view of the tail strike device of FIG. 7 at a first pitch angle in a deployed position;

FIG. 21D is an enlarged side view of the tail strike device of FIG. 7 at a second pitch angle in a deployed position;

FIG. 21E is an enlarged side view of the tail strike device of FIG. 7 at a first roll angle in a deployed position;

FIG. 22 is an enlarged side perspective view of a tail strike device according to a further aspect of the present disclosure, the tail strike device including a wheel arranged on the tail skid;

FIG. 23 is an enlarged side view of the tail strike device of FIG. 22;

FIG. 24 is an enlarged perspective view of a tail strike device according to a further aspect of the present disclosure, the tail strike device including an air bag;

FIG. 25 is an enlarged side perspective view of the tail strike device of FIG. 24;

FIG. 26 is an enlarged side view of the tail strike device of FIG. 24;

FIG. 27 is an enlarged side view of the tail strike device of FIG. 24, showing a fairing surrounding the airbag to reduce drag;

FIG. 28 is an enlarged view of a tail strike device according to a further aspect of the present disclosure in a deployed position, shown with a semi-transparent portion of a fuselage of the aircraft;

FIG. 29 is a plan view taken of the bottom of the tail strike device of FIG. 28;

FIG. 30 is an upwards angled perspective side view of the tail strike device of FIG. 28;

FIG. 31 is a schematic illustration of forces imparted on the tail strike device of FIG. 28 and the fuselage upon contact of the tail strike device with a landing surface;

FIG. 32 is an enlarged view of one embodiment of the tail strike device of FIG. 28 in a retracted position shown with a semi-transparent portion of the fuselage of the aircraft;

FIG. 33 is a graph of a vertical reaction load at an aft linkage and an axial crush-can load on a crush can of the tail strike device of FIG. 28;

FIG. 34 is a graph of rotational velocity at tail strike impact ranges of the tail strike device of FIG. 28;

FIG. 35 is a perspective view of a mesh model of the aircraft on which the tail strike device of FIG. 28 is utilized, showing a linear static load case setup with an aft fuselage brick-wall;

FIG. 36 is a graph of simulation results of the tail strike device of FIG. 28; and

FIG. 37 is a schematic block diagram of one exemplary embodiment of a computer system for use in conjunction with the present disclosures.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

Further, the present disclosure provides some illustrations and descriptions that include prototypes, bench models, and/or schematic illustrations of set-ups. A person skilled in the art will recognize how to rely upon the present disclosure to integrate the techniques, systems, devices, and methods provided for herein into a product and/or a system provided to customers, such customers including but not limited to individuals in the public or a company that will utilize the same within manufacturing facilities or the like. To the extent features are described as being disposed on top of, below, next to, etc. such descriptions are typically provided for convenience of description, and a person skilled in the art will recognize that, unless stated or understood otherwise, other locations and positions are possible without departing from the spirit of the present disclosure.

Unless otherwise defined, all technical terms used herein have the same meaning as commonly understood by one of ordinary skill in the art to which this disclosure belongs. Additionally, like-numbered components across embodiments generally have similar features unless otherwise stated or a person skilled in the art will appreciate differences based on the present disclosure and his/her knowledge. Accordingly, aspects and features of every embodiment may not be described with respect to each embodiment, but those aspects and features are applicable to the various embodiments unless statements or understandings are to the contrary.

Methods and devices to mitigate or prevent an aft end, or tail, of an aircraft from striking the ground, e.g., an upper surface of a runway, when taking off or landing are provided for herein. The runway can be, for example, a semi-prepared runway. As provided for herein, and as understood by a person skilled in the art, semi-prepared runway operations (SPRO) is a term used to describe when aircraft operate from a range of runway conditions that are somewhat worse than that of typical paved runways due to, for example, a reduction in the runway preparation, specifically lack of pavement. Some non-limiting examples of semi-prepared runways include those made of dirt and/or a compacted soil aggregate, which may include sand, silt, gravel, and/or rocks. Semi-prepared runways can be formed at many locations where a typical paved runway may not be possible and/or practical (e.g., because of the amount of land available, because of the conditions, because of not wanting to build a more typical paved runway at a particular location). These locations can include a field, a dry riverbed, a frozen surface, and/or a desert, among others. The present disclosure contemplates forming semi-prepared runways at locations where onshore wind farms are to be built, although the present disclosure can also be utilized on aircraft landing at other locations and/or for other purposes, even aircraft landing on more traditional paved runways.

Parameters that define the degree of SPRO include surface hardness (defined in terms of California Bearing Ratio (CBR)), roughness, braking friction, and/or rolling friction. Braking and rolling friction are governed by a combination of surface friction and till depth, which is the depth of loose dirt from runway damage sustained while taxiing, takeoffs, and landings. For a SPRO runway, these parameters are much more demanding on the aircraft, specifically the aircraft landing gear and any sort of tailstrike device. Because the aircraft of the present disclosure provides for a tailstrike device, special consideration was made to the design of the tailstrike device, and its associated components for coupling to aircraft, so that it remains effective on SPRO runways.

To mitigate or eliminate the impact of a tail strike to a fuselage of an aircraft and/or the continued operation of the aircraft in the event of such a tail strike, tail strike devices of the present disclosure can: (1) reduce the overall force during a trail strike incident; (2) absorb the load in a predictable manor, (3) avoid damaging the semi-prepared runway as much as possible, and (4) provide an indicator of the severity and/or magnitude of an impact after it occurs.

Tail strike devices of the present disclosure can include a tail skid, tail ski, or semi-prepared runway operations (SPRO) board (used interchangeably herein) that can contact a runway or landing surface with a significantly larger impact surface than conventional tail strike devices in instances in which an aircraft exceeds a threshold degree of rotation and/or rotational velocity. Further, SPRO boards of the present disclosure can be or have a high flotation impact surface that can reduce a total pressure imparted by the tail strike device onto a runway. As such, tail strike devices disclosed herein can effectively reduce and/or eliminate damage to an aircraft during a takeoff or landing on a semi-prepared runway in instances in which the aircraft tail would otherwise strike, or does strike, the runway. By way of non-limiting example, a semi-prepared runway can have a landing surface that includes, at least in part, packed gravel, native soil, cement stabilized native soil, metal runway mats, geotechnical stabilizing meshes, etc. Tail strike devices of the present disclosure can match flotation performance of a landing gear of an aircraft, e.g., by utilizing a SPRO board with a large impact surface, as compared with conventional tail skid devices, for contact with a landing surface.

A stroke length of the tail strike device can be sized to reduce the total force in the event of a nominal tail strike incident such that a primary airframe structure is not permanently damaged. The stroke length of the tail strike device can be measured as a distance between a surface of the fuselage of the aircraft to the upper layer of the tail skid measured along a vector normal to the surface of the fuselage and the upper layer of the tail skid in a fully deployed position. The impact speed during a nominal tail strike occurrence can be estimated, e.g., with flight simulation data, hand calculation methods, physical test data, or a combination of the above. The tail strike device of the present disclosure should include a means of absorbing load over some amount of distance via a stroking mechanism.

### Aircraft

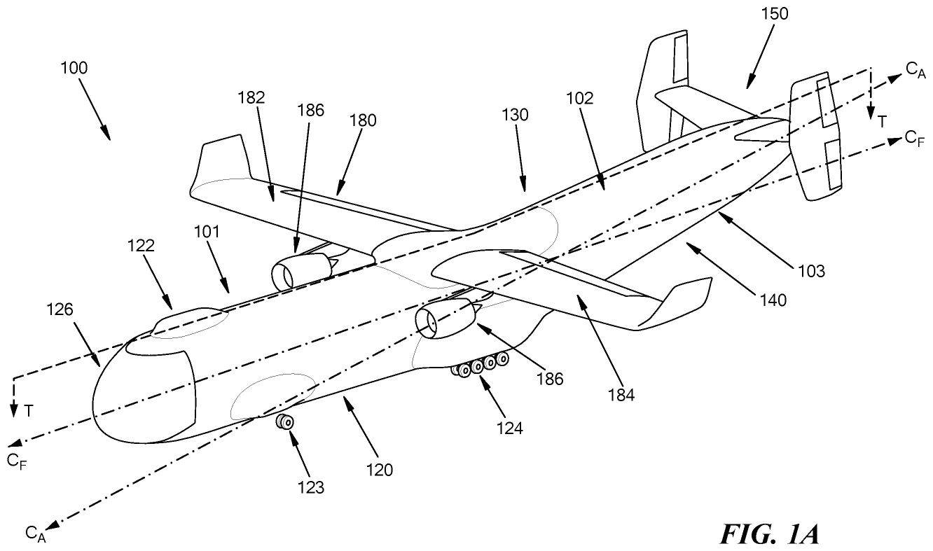

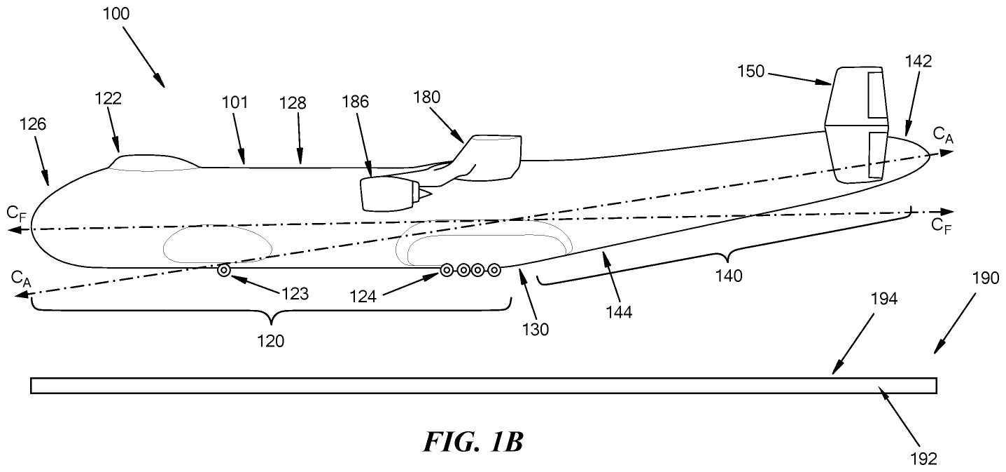

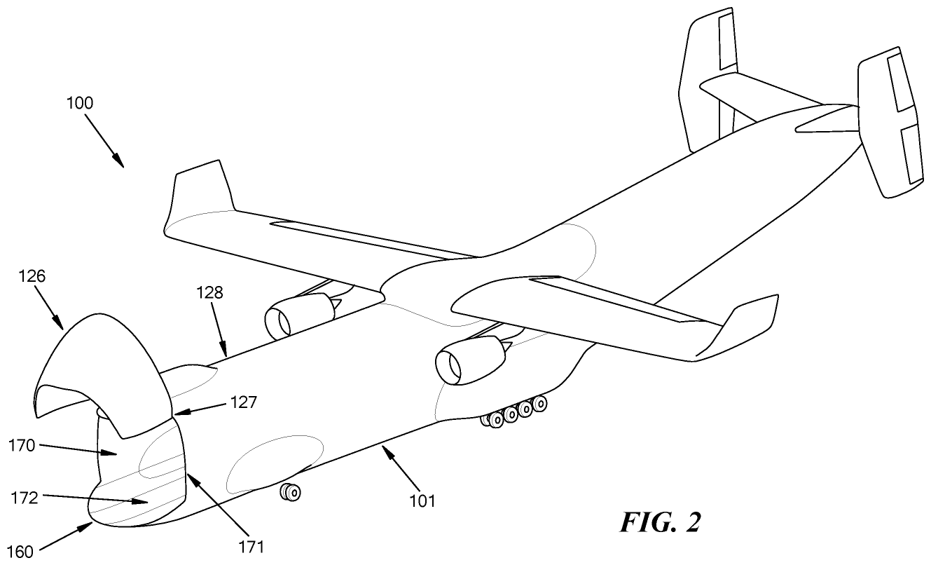

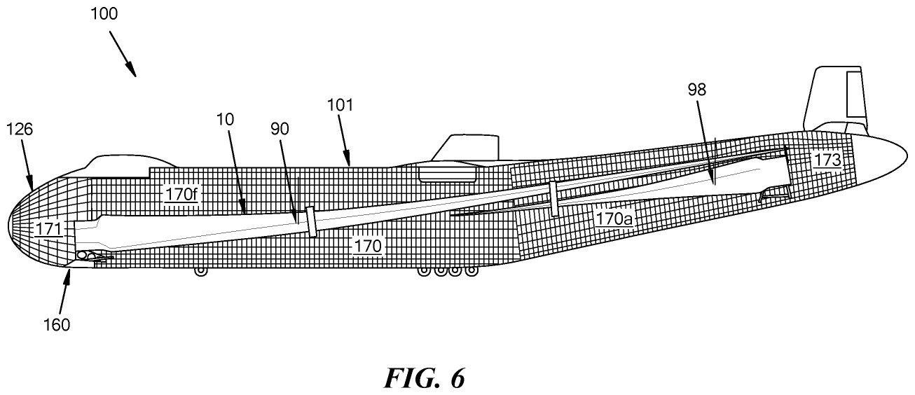

The focus of the present disclosures is described with respect to a large aircraft 100, such as an airplane, illustrated in FIGS. 1A and 1B, along with the loading of a large payload into the aircraft, illustrated at least in FIGS. 2 and 6. In the illustrated embodiment, a payload 10 is a combination of two wind turbine blades 90, 98 (FIG. 6), although a person skilled in the art will appreciate that other payloads are possible. Such payloads can include other numbers of wind turbine blades (e.g., one, two, three, four, etc., or segments of a single even larger blade), other components of wind turbines (e.g., tower segments, generator, hub, etc.), or other large structures and objects whether related to wind turbines or not. The present application can be used in conjunction with most any large payload-large for the present purposes being at least about 57 meters long, or at least about 60, 65, 75, 85, 90, 100, 110, or 120 meters long—or for smaller payloads if desired. Beyond wind turbines, the aircraft 100 can be used with most any size and shape payload, but has particular utility when it comes to large, often heavy and/or bulky and/or irregularly-shaped, payloads.

As shown, for example in FIGS. 1A, 1B, and 2, the aircraft 100, and thus its fuselage 101, includes a forward end 120 and an aft end 140, with a kinked portion 130 connecting the forward end 120 to the aft end 140. The forward end 120 is generally considered any portion of the aircraft 100, and related components, that are forward of the kinked portion 130 and the aft end 140 is considered any portion of the aircraft 100, and related components, that are aft of the kinked portion 130. The kinked portion 130 is a section of the aircraft 130 in which both a top-most outer surface 102 and a bottom-most outer surface 103 of the fuselage 101 become angled, as illustrated by an aft centerline CA of the aft end 140 of the fuselage 101 with respect to a forward centerline CF of the forward end 120 of the fuselage 101. The aft end 140 includes an aft bottom surface 144.

The forward end 120 can include a cockpit or flight deck 122, as shown located at a top portion of the aircraft, thus providing more space for cargo, and landing gears, as shown a forward or nose landing gear 123 and a rear or main landing gear 124. The forward-most end of the forward end 120 includes a nose cone 126. As illustrated more clearly in FIG. 2, the nose cone 126 can be functional as a door, optionally referred to as the nose cone door 126, opening about a hinge 127, thus allowing access to an interior cargo bay 170 defined by the fuselage 101 via a cargo opening 171 exposed by moving the nose cone door 126 into an open or loading position as shown.

The interior cargo bay 170 is continuous throughout the length of the aircraft 101, i.e., it spans a majority of the length of the fuselage. The continuous length of the interior cargo bay 170 includes the space defined by the fuselage 101 in the forward end 120 defining a forward bay portion of the cargo bay 170, the aft end 140 defining an aft bay portion of the cargo bay 170, and the kinked portion 130 defining a kinked bay portion of the cargo bay 170 disposed therebetween. The interior cargo bay 170 can thus include the volume defined by nose cone 126 when closed, as well as the volume defined proximate to a fuselage tailcone 142 located at the aft end 140. The fixed portion 128 of the forwards fuselage 101 is the portion that is not the nose cone 126, and thus the forwards fuselage 101 is a combination of the fixed portion 128 and the nose cone 126. Alternatively, or additionally, the interior cargo bay 170 can be accessed through other means of access, including but not limited to a door located in the aft end 140.

One advantage provided by the illustrated configuration is that by not including an aft door, the interior cargo bay 170 can be continuous, making it significantly easier to stow cargo in the aft end 140 all the way into the fuselage tailcone 142. Existing large cargo aircraft are typically unable to add cargo in this way (e.g., upwards and aftwards) because any kink present in their aft fuselage is specifically to create more vertical space for an aft door to allow large cargo into the forwards portion of the aircraft. Opening the nose cone 126 not only exposes the cargo opening 171 and a floor 172, but it also provides access from an outside environment to a cantilevered tongue 160 that extends from or otherwise defines a forward-most portion of the fixed portion 128 of the fuselage 101.

A wingspan 180 can extend substantially laterally in both directions from the fuselage. The wingspan 180 includes both a first and second fixed wings 182, extending substantially perpendicular to the fuselage 101. In the illustrated embodiment, two engines 186, one mounted to each wing 182, 184, are provided, and other locations for engines are possible, such as being mounted to the fuselage 101. More than two engines, such as three, four, or six, may also be used.

The kinked portion 130 provides for an upward transition between the forward end 120 and the aft end 140. The kinked portion 130 includes a kink, i.e., a bend, in the fixed portion 128 of the fuselage 101 such that both the top-most outer surface 102 and the bottom-most outer surface 103 of the fuselage 101 become angled with respect to the centerline CF of the forward end 120 of the aircraft 100. Notably, although the present disclosure generally describes the portions associated with the aft end 140 as being “aft,” in some instances they may be referred to as part of a “kinked portion” or the like because the entirety of the aft end 140 is angled as a result of the kinked portion 130. Despite the angled nature of the aft end 140, the aircraft 100 is specifically designed in a manner that allows for the volume defined by the aft end 140, up to almost the very aft-most tip of the aft end 140, i.e., the fuselage tailcone 142, to receive cargo as part of the continuous interior cargo bay 170.

Proximate to the fuselage tailcone 142 can be an empennage 150, which can include horizontal stabilizers for providing longitudinal stability, elevators for controlling pitch, vertical stabilizers for providing lateral-directional stability, and rudders for controlling yaw, among other empennage components known to those skilled in the art.

The aircraft 100 is particularly well-suited for large payloads because of a variety of features, including its size. A length from the forward-most tip of the nose cone 126 to the aft-most tip of the fuselage tailcone 142 can be approximately in the range of about 60 meters to about 150 meters. Some non-limiting lengths of the aircraft 100 can include about 80 meters, about 84 meters, about 90 meters, about 95 meters, about 100 meters, about 105 meters, about 107 meters, about 110 meters, about 115 meters, or about 120 meters. Shorter and longer lengths are possible. A volume of the interior cargo bay 170, inclusive of the volume defined by the nose cone 126 and the volume defined in the fuselage tailcone 142, both of which can be used to stow cargo, can be approximately in the range of about 1200 cubic meters to about 12,000 cubic meters, the volume being dependent at least on the length of the aircraft 100 and an approximate diameter of the fuselage (which can change across the length). One non-limiting volume of the interior cargo bay 170 can be about 6850 cubic meters. Not accounting for the very terminal ends of the interior cargo bay 170 where diameters get smaller at the terminal ends of the fuselage 101, diameters across the length of the fuselage, as measured from an interior thereof (thus defining the volume of the cargo bay) can be approximately in the range of about 4.3 meters to about 13 meters, or approximately in the range of about 8 meters to about 11 meters. One non-limiting diameter of the fuselage 101 proximate to its midpoint can be about 9 meters. One non-limiting length of the wingspan 180 can be about 80 meters.

A person skilled in the art will recognize these sizes and dimensions are based on a variety of factors, and thus they are by no means limiting. Nevertheless, the large sizes that the present disclosure both provides the benefit of being able to transport large payloads, but faces challenges due, at least in part, to its size that make creating such a large aircraft challenging. The engineering involved is not merely making a plane larger. As a result, many innovations tied to the aircraft 100 provided for herein, and in other commonly-owned patent applications, are the result of very specific design solutions arrived at by way of engineering.

### Kinked Fuselage

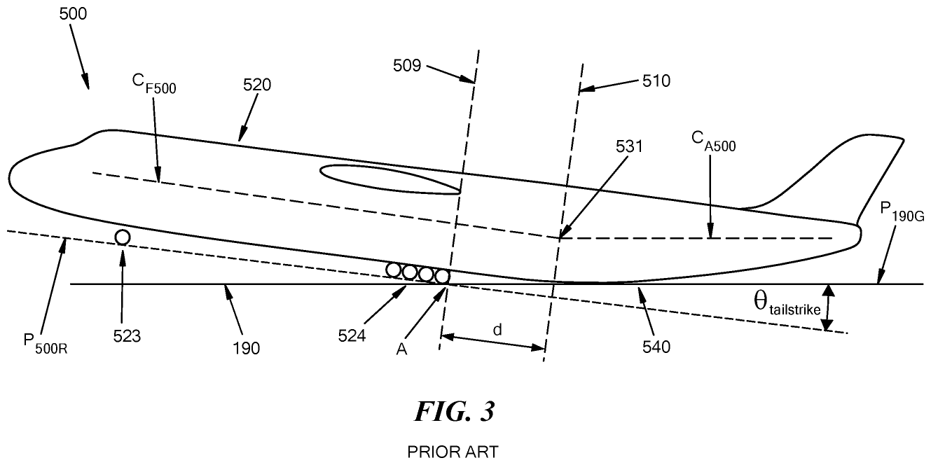

FIG. 3 is an illustration of a prior art aircraft 500 during a takeoff pitch-up maneuver showing the calculating of a tailstrike angle (θₜₐᵢₗₛₜᵣᵢₖₑ), which is determined when a forward end 520 of the aircraft 500 is lifted away from the ground, as defined by a ground plane P_{190G} (e.g., a runway of an airport or a semi-prepared runway as provided for herein, such as the runway 190 shown in FIG. 1B) and an aft end 540 and tail of the aircraft 500 is pushed towards the ground or runway 190 until contact. This change occurs during a takeoff pitch-up maneuver when the aircraft 500 pitches (e.g., rotates) about a lateral axis of rotation, indicated as “A” in FIG. 3. This lateral axis of rotation, A, is typically defined by the main landing gear 524, which acts as a pivot point to allow a downwards force generated by the tail to lift the forward end 520 of the aircraft 500. In FIG. 3, the nose landing gear 523 and main landing gear 524 define a resting plane P_{500R} (e.g., plane horizontal with the ground plane P_{190G} when the aircraft is resting), such that the tailstrike angle θₜₐᵢₗₛₜᵣᵢₖₑ can be defined by the change in the angle of the ground plane P_{190G} with respect to the resting plane P_{500R} when the aircraft 500 has achieved a maximal pitch angle or takeoff angle, which occurs just before any part of the aft end 540 of the aircraft 500 strikes the ground. In FIG. 3, a forward center line C_{F500} of the aircraft 500 is shown, along with an aft centerline C_{A500}. In order to increase θₜₐᵢₗₛₜᵣᵢₖₑ, larger aircraft 500 usually have an upsweep to the lower surface of an aft region of the aft fuselage. This upsweep deflects the centerline C_{A500} with respect to the forward center line C_{F500} at the initiation of the upsweep, which is shown in FIG. 3 as a bend 531 in the centerlines C_{F500}, C_{A500}. In prior art aircraft 500, this bend 531 occurs a certain distance, shown in FIG. 3 as distance “d” aft of the lateral axis of rotation A. Longer values of distance “d” increase the constant cross-section length of the aircraft 500. Aspects of the present disclosure eschew this prior art incentive for increasing distance “d” and instead significantly reconfigure the relationship between the aft fuselage and forward fuselage such that decreasing distance “d” can result in increasing the maximum usable cargo bay length.

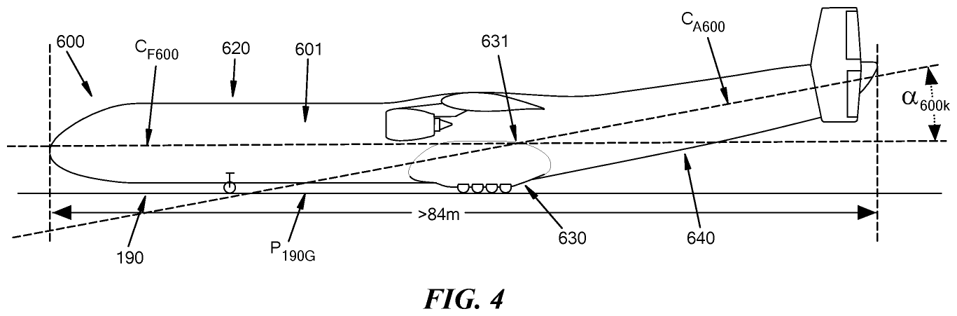

FIG. 4 is a side view illustration of an exemplary cargo aircraft 600 of the present disclosure. The aircraft 600, which is shown to be over 84 meters long, includes a fuselage 601 having a forward end 620 defining a forward centerline C_{F600} and an aft end 640 defining an aft centerline C_{A600}, with the aft centerline C_{A600} being angled up with respect to the forward centerline C_{F600}. The forward and aft centerlines C_{F600}, C_{A600} define a junction or kink 631 therebetween, where the forward centerline C_{F600} angles upward as the overall aft fuselage, which is in the aft end 640, changes in direction to be angled with respect to the forward fuselage, which is in the forward end 620. This defines a kink angle α₆₀₀ₖ of the aft fuselage 640. The kink location 631 is contained in the kinked portion 430 disposed between and connecting the forward and aft ends 620, 640.

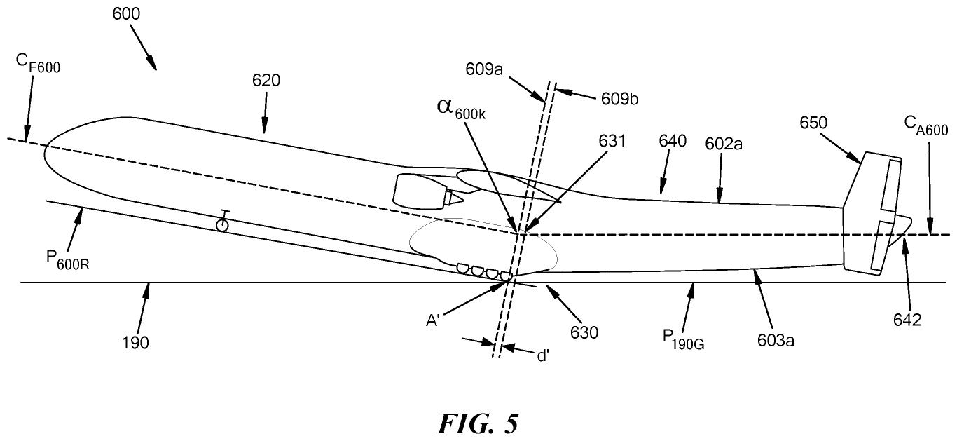

In FIG. 5, the angle of the aft centerline C_{A600} with respect to the forward centerline C_{F600} defines a kink or bend angle (illustrated as α_{600K} in FIG. 4), which can be approximately equal to an average of an angle of the after upper surface 602a and an angle of the lower surface 603a with respect to the forward centerline C_{F600}. Further, the kink angle (600K can be approximately equal to a degree of maximal rotation of the aircraft during the takeoff operation. In FIG. 5, the cargo aircraft 600 is shown on the ground 190 and rotated about the lateral axis of rotation to illustrate, for example, a takeoff pitch-up maneuver. In FIG. 5, a resting plane P_{600R} of the forward end 620 angled with respect to the ground or ground plane P_{190G} at a degree just before θₜₐᵢₗₛₜᵣᵢₖₑ, as no part of the aft end 640, empennage 650, or tail 642 is contacting the ground. In this position, the lower surface 603a (and, approximately, the aft centerline C_{A600}) is substantially parallel with the ground or ground plane P_{190G}, and it can be seen that because the location of the centerline kink 631 of the kinked portion 630 is approximately with, or very close to, the lateral axis of rotation A′, the angle α₆₀₀ₖ of the kink 631 is approximately the maximum safe angle of rotation of the aircraft 600 about the lateral axis of rotation A′.

FIG. 5 shows a vertical axis 609a aligned with the location of the lateral axis of rotation A′ and another vertical axis 609b aligned with the kink 631 in the fuselage centerline C_{F600}, with a distance d′ therebetween. With d′ being small, and the lower surface 603a of the aft end 640 extending aft with approximately the kink angle α₆₀₀ₖ of the kink 631 or a slightly larger angle, as shown, the aft end 640 is highly elongated without risking a tail strike. Moreover, the upward sweep of the upper surface 602a can be arranged to maintain a relatively large cross-sectional area along most of the aft end 640, thereby enabling a substantial increase in the overall length of the cargo aircraft 600, and thus usable interior cargo bay within the aft end 640, without increasing θₜₐᵢₗₛₜᵣᵢₖₑ. Vertically aligning the kink location 131 with the lateral pitch axis can enable the aft fuselage 140 to extend without decreasing θₜₐᵢₗₛₜᵣᵢₖₑ, which also can enable the useable portion of the interior cargo bay 170 to extend aft along a substantial portion of the aft fuselage 140. The present designs also enable the creation of extremely long aircraft designs capable of executing takeoff and landing operations with shorter runway lengths than previously possible.

Examples of the aircraft 100 also include complex fuselage changes (e.g., the forward-to-aft kink or bend angle in the fuselage and interior cargo bay centerline) occurring over multiple transverse frames and longitudinally continuous skin panels, thus reducing the overall structural complexity of the transition zone. Additional details about kinked fuselages are provided in International Patent Application No. PCT/US2021/021792, entitled “AIRCRAFT FUSELAGE CONFIGURATIONS FOR UPWARD DEFLECTION OF AFT FUSELAGE,” and filed Mar. 10, 2021, and the content of which is incorporated by reference herein in its entirety.

### Cargo Bay

FIG. 6 is side cross-section view of the cargo aircraft 100, the cross-section being taken along an approximate midline T-T of the top-most outer surface, as shown in FIG. 1A. The cargo bay 170 extends from a forward end 171 of a forward end or region 170f of the cargo bay 170, as shown located in the nose cone 126, to an aft end 173 of an aft end or region 170a of the cargo bay 170, as shown located in the fuselage tailcone 142. The forward and aft regions 170f, 170a of the cargo bay 170 sit within the forward and aft ends 120, 140, respectively, of the aircraft 100. FIG. 6 shows the aft region 170a of the cargo bay 170 extending through almost all of the aft fuselage 140, which is a distinct advantage of the configurations discussed herein. FIG. 6 shows a highly elongated payload 10 of two wind turbine blades 90, 98 disposed substantially throughout the interior cargo bay 170 and extending from the forward end 171 of the forward region 170f to the aft end 173 of the aft region 170a.

### Tail Strike Mitigation

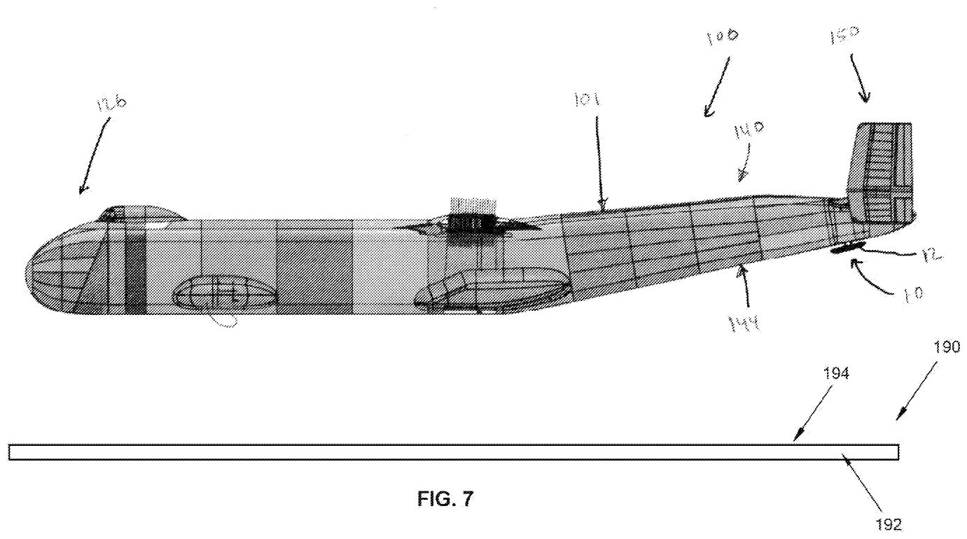

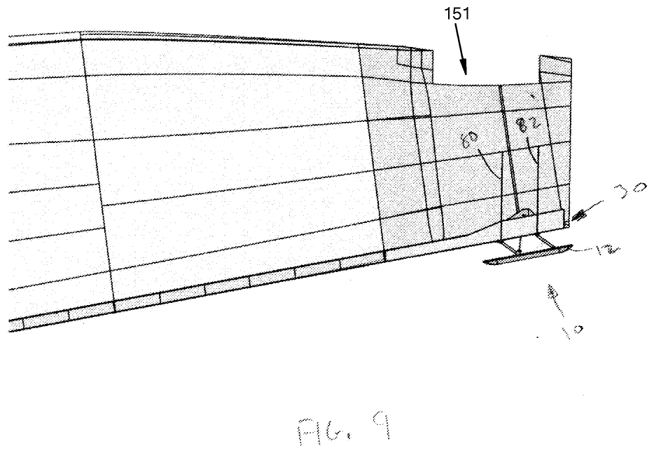

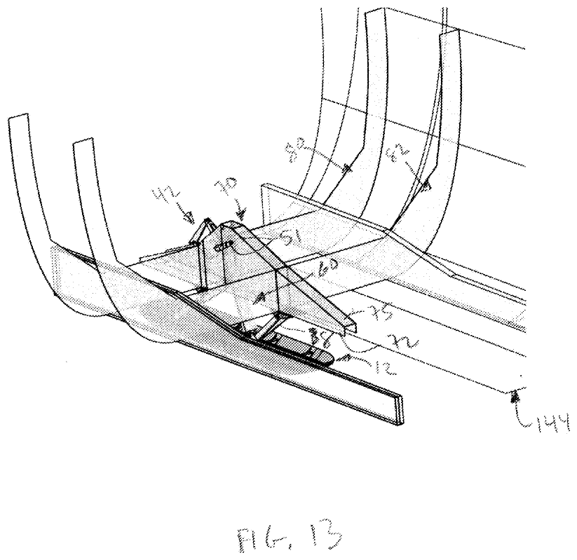

FIGS. 7-10 illustrates one embodiment of the aircraft 100 including a tail strike device 10 of the present disclosure. The tail strike device 10 can extend from a belly or bottom surface 144 of the aft end 140 of the fuselage 101 of the aircraft 100 approximately or substantially underneath the tail or empennage 150 of the aircraft 100. A tail skid, or SPRO board 12, of the tail strike device 10 can be located substantially underneath the empennage 150. The tail strike device 10 can be placed far enough aft as to not reduce a tail strike angle more than a few degrees when the tail strike device 10 is deployed. The tail strike device 10 can attach to a forward spar plane frame 80 (see FIGS. 9, 12, and 13) of a horizontal stabilizer and adjacent aft frame(s) 82 (see FIGS. 9, 12, and 13). In instances in which the aircraft 100 includes a payload rail structure, as described for example in International Patent Application No. PCT/US2020/049784, the contents of which is incorporated by reference herein in its entirety, the tail strike device 10 can be located aft or just aft of where the payload rail structure ends. Such placement can prevent the tail strike device 10 from interfering with payload carried by the aircraft 100 and/or supporting payload structure(s).

As shown in FIG. 7, the aircraft 100 is operable to takeoff and land on a runway 190, which in at least some embodiments can be a semi-prepared runway. In some embodiments, the semi-prepared runway 190 can include a base layer 192 forming a foundation of the runway 190. The base layer 192 can include, at least in part, packed gravel, native soil, cement stabilized native soil, metal runway mats, geotechnical stabilizing meshes, etc. The base layer 192 can define an upper landing surface 194. The aircraft 100 can be supported by and contact the upper landing surface 194 during takeoff and landing, in particular via the landing gears 123, 124.

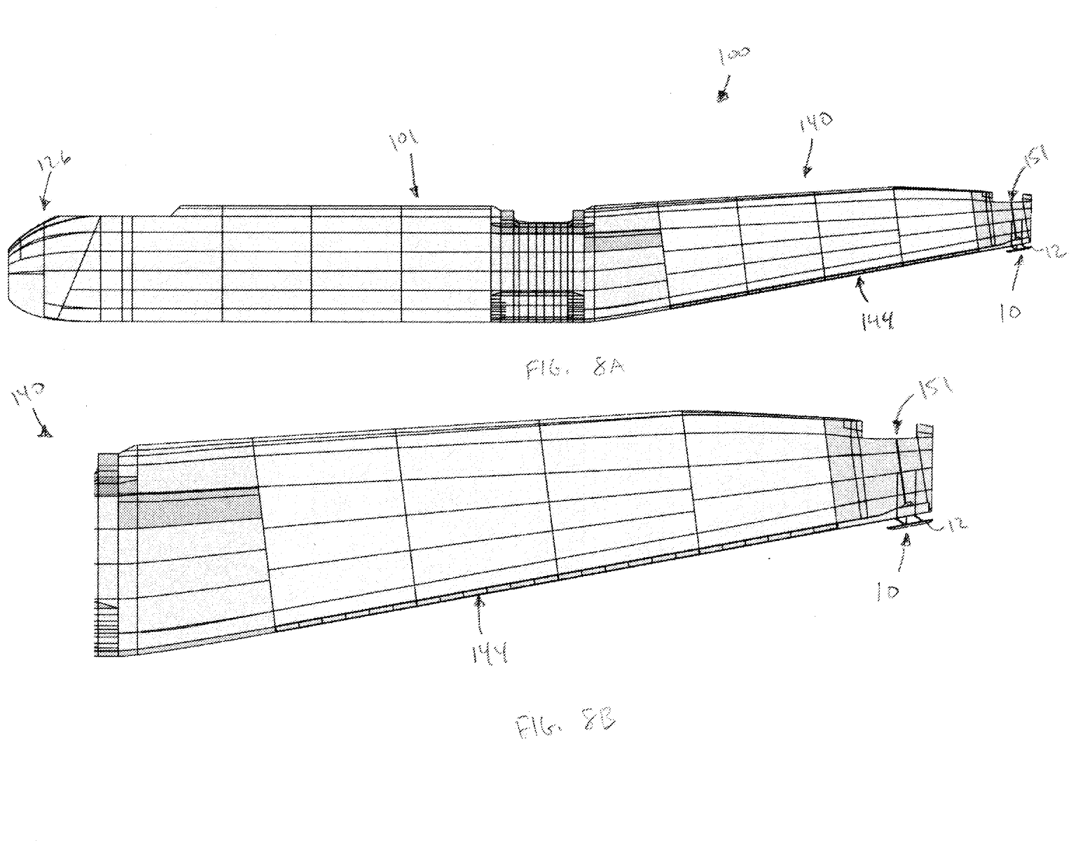

FIGS. 8A-9 show various views of the tail strike device 10 coupled to a bottom surface 144 of the aft end 140 of the fuselage 101 of the aircraft 100. As can be seen in FIG. 8A, the tail strike device 10 is coupled to the bottom surface 144 proximate to a recessed portion 151 of the fuselage 101 formed for receiving the horizontal stabilizers of the empennage 150. In some embodiments, the tail strike device 10 is arranged substantially underneath the recessed portion 151 such that a majority of the SPRO board 12 is located directly beneath the recessed portion 151, as shown in FIGS. 8A and 8B. FIG. 8B shows only the aft end 140 of the fuselage 101, while showing the tail strike device 10 in greater detail. FIG. 9 shows the aftmost portion of the aft end 140, showing the tail strike device 10 including the SPRO board 12 and a retraction system 30 for movably connecting the SPRO board 12 to the aircraft 100 such that the SPRO board 12 can be moved with respect the aircraft 100 as desired. In the illustrated embodiment, the retraction system 30 comprises a plurality of linkages, and thus can be referred to as a linkage system, although a person skilled in the art will appreciate other mechanical and/or electrical mechanisms that can comprise the retraction system, and thus can be used in addition to and/or in lieu of linkages, to provide movement of the SPRO board 12 with respect to the aircraft 100.

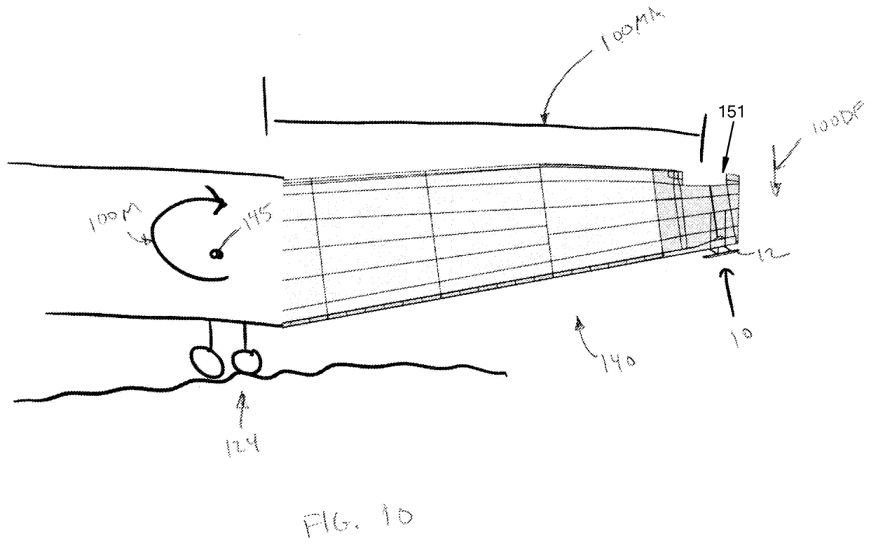

FIG. 10 shows a schematic view of the aft end 140 and the tail strike device 10. FIG. 10 shows a moment arm 100MA of the aircraft 100 as the aircraft 100 rotates about the pivot point 145 and the moment 100M about the pivot point 145. A downward force 100DF will be exerted (by the horizontal tail) on the aft end 140 of the fuselage 101 during a pitch-up maneuver, thus causing the moment 100M on the aircraft 100. This, in turn, can cause tailstrike to occur, for example, during a takeoff or landing operation. By positioning the SPRO board 12 below the recessed portion 151, i.e., at a location that is proximate to or at a distal-most end of the aft end 140 of the fuselage 101, the force required to arrest the angular velocity during a tail strike event at the tail SPRO board 12 can be minimized. For a constant angular momentum at impact, the longer the moment arm 100MA between the center of rotation 145 and the location in question, the smaller the impact force, and, as such, the structure can be lighter and the SPRO board 12 surface area made smaller.

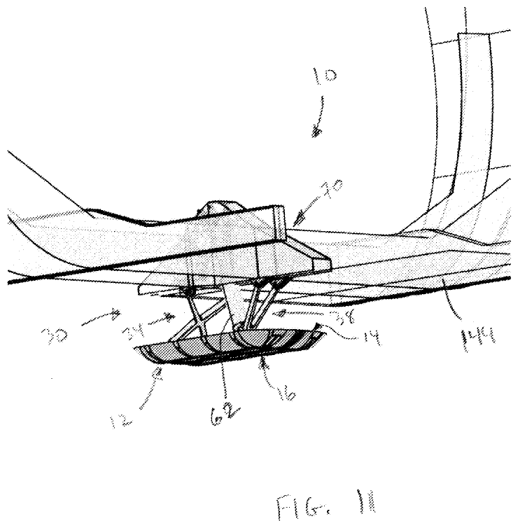

FIGS. 11-21B illustrate one embodiment of the tail strike device 10 of the aircraft 100. As can be seen in FIGS. 11-13, the tail strike device 10 protrudes or extends from the bottom surface or belly 144 of the airframe, as shown the aft end 140 of the fuselage 101, in a deployed position, i.e., a position to mitigate a tail strike incident. The tail strike device 10 can include a SPRO board 12 that can have an upper layer or surface 14 and a lower layer or surface 16 coupled to each other. The lower surface 16 can be configured to contact a runway or a landing surface in the event of a potential tail strike, which can occur, for example, due to over-rotation of the aircraft during takeoff or landing. The lower surface 16 can be a high flotation impact surface such that the SPRO board 12 can skim or skid over the runway or landing surface, even when the runway is semi-prepared, e.g., not fully paved. The SPRO board 12 can be coupled to the aircraft 100 by a retraction system 30. One non-limiting example of a retraction system is illustrated by a linkage system that includes a first linkage 34 and a second linkage 38. The retraction system 30 may further include an upper retraction assembly 42 configured to move the SPRO board 12 between the deployed and retracted positions.

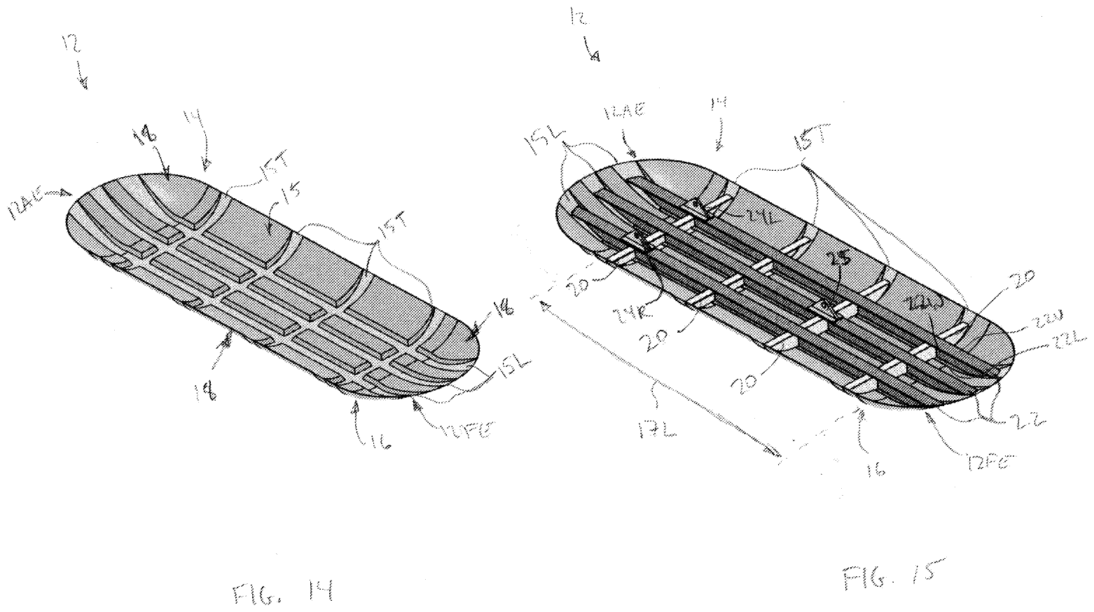

FIGS. 14-18 shows various views of the SPRO board 12. The SPRO board 12 can serve as a high flotation impact surface such that the SPRO board 12 can skim or skid across a semi-prepared runway without rutting or gouging into the runway. Moreover, the SPRO board 12 can be constructed such that predictable loads can be transmitted to the aircraft upon contact of the SPRO board 12 with the runway and can be sized so as to maximize a distribution of force from the runway to the SPRO board 12. Because SPRO boards 12 of the present disclosure can travel across a semi-prepared runway surface without rutting, harm to the runway can be avoided and damage to the aircraft can be mitigated by reducing or removing unpredictability of the loads. In particular, the SPRO board 12 can skim along the upper landing surface 194 of the semi-prepared runway 190 without gouging through the upper landing surface 194 and into the base layer 192 of the runway 190 (see FIG. 7). In some embodiments, the SPRO board 12 can be rotated such that the forward end 12FE of the SPRO board 12 is higher than the aft end 12AE of the SPRO board 12 relative to the landing surface 192 during landing of the aircraft 100 so as to prevent gouging of the runway 190. Additional details about the ability to control a position of the SPRO board 12 with respect to a runway and/or the aircraft are provided below.

In some embodiments, the SPRO board 12 can resemble a ski or a sled. In some embodiments, the SPRO board 12 can include an upper surface 14 and a lower surface 16. In some embodiments, the perimeter of the upper surface 14 is aligned with the perimeter of the lower surface 16 such that the two surfaces 14, 16 are sized complementarily to each other. A person skilled in the art will understand that additional surfaces, layers, and the like can be utilized to form the SPRO board 12, such as a form core or composite as described in greater detail below, or that the layers can be integrally formed so as to form a monolithic SPRO board 12.

The lower surface 16 of the SPRO board 12 can include a generally planar bottom surface portion 17, sometimes referred to as an impact surface portion, and radial fillet curved edges 18, as shown in FIGS. 14-18. The bottom surface portion 17, also referred to as an impact surface or a contact surface herein, can be designed to contact and skid over the runway 190. For example, the bottom surface portion 17 of the SPRO board 12 can be an elongated rectangle with a length 17L larger than a width 17W. A person skilled in the art will understand that it is possible that the width 17W can be larger than the length 17L. By way of non-limiting examples, the length 17L can be approximately in the range of about 50 centimeters to about 250 centimeters, and the width 17W can be approximately in the range of about 10 centimeters to about 70 centimeters, and in one embodiment a length can be about 175 centimeters and a width can be about 35 centimeters. A surface area of the planer bottom surface portion 17 of the SPRO board 12 can be approximately in the range of about 0.1 square meters to about 1.0 square meters, and in one embodiment a surface area of the bottom surface portion 17 can be approximately 0.7 square meters. More generally, a person skilled in the art will appreciate the size of the SPRO board 12 is significantly larger than existing tailstrike mitigation devices, having a form factor for its surface area of comparable bottom surfaces at least 10 times larger, and typically at least 100 times larger, than existing tail strike mitigation devices, and in some embodiments having a form factor for its surface area of comparable bottom surfaces that is approximately in the range of about 10 times larger to about 200 times larger than existing tail strike mitigation devices. A person skilled in the art will appreciate that other configurations, sizes, and shapes of the SPRO board are possible without departing from the spirit of the present disclosure.

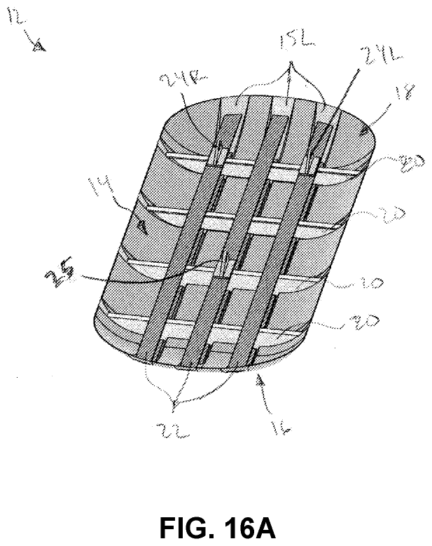

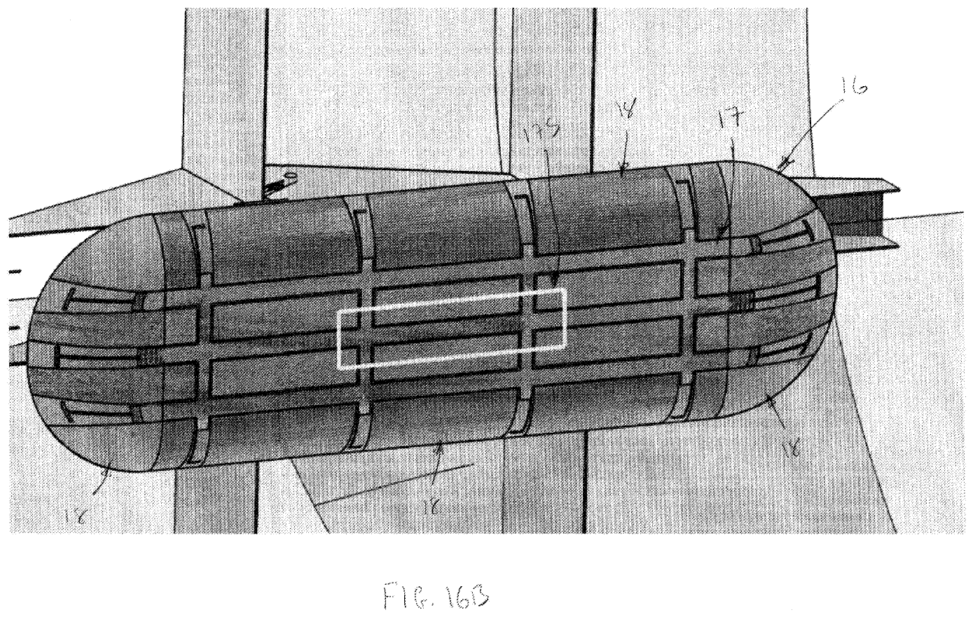

Functionally, the impact surface portion 17 of the SPRO board 12 can be sized to exert a pressure on the runway that is equal to or less than a maximum pressure exerted on a runway by landing gear tires 123, 124 under their highest vertical load case (see FIGS. 1A and 1B). In some embodiments, the impact surface portion 17 can include a metallic strip 17S or other hard material arranged thereon, as shown in FIG. 16B, for increased wear resistance in the case when a tail strike occurs on a paved runway. In the paved runway tail strike scenario, the large surface area of the SPRO board 12 may not be required to distribute the load onto a low CBR surface. Instead, without wear strips, the SPRO board 12 may be damaged and ground through from the surface abrasion with the runway 190. Metallic strips aligned closely with SPRO board 12 attachment fittings 24R, 24L, and 25 can mitigate this concern. This could also be mitigated in some embodiments via a wheel or wheels attached to the SPRO board 12, as will be described in greater detail below.

The SPRO board 12 can have radial fillet curved edges 18 that surround the impact surface 17. If the SPRO board were to dig in it would cause loads that may rip the SPRO board off of the aircraft aft fuselage 140. The curved or radiused edges 18 of the SPRO board 12 can enable the SPRO board 12 to slide over a SPRO runway without catching an edge or otherwise digging into the runway surface, and as such can reduce or eliminate the event of the SPRO board being ripped off the aircraft. Further, the curved edges 18 can assist in allowing the aircraft 100 to experience a tail strike while minimizing or eliminating potential damage to the aft end 140 of the aircraft 100 and/or the runway due to aircraft yaw angle at the moment of SPRO board impact with the ground. The curved edges 18 can extend away from the impact surface 17 and curve upwardly toward the fuselage 101. In some embodiments, as shown in FIG. 18, the curved edges 18 can curve upwardly to an angle 18A relative to the horizontal plane of the impact surface 17 of less than 90 degrees. In some embodiments, the angle 18A can be approximately in the range of about 10 degrees to about 90 degrees. In some embodiments the angle 18A can be approximately in the range of about 30 degrees to about 60 degrees, and in some embodiments the angle 18A can be about 50 degrees. Still further, in some embodiments, the angle 18A can be greater than 90 degrees so as to form a rounded top perimeter edge of the SPRO board 12.

The SPRO board 12 can further include components to reinforce the board 12 to provide increased robustness in response to forces experienced by the board 12 during impact. As shown in FIG. 14, the upper surface 14 can include a plurality of transverse open slots 15T that extend across a transverse extent of the upper surface 14, and a plurality of longitudinal open slots 15L that extend across a longitudinal extent of the upper surface 14. In some embodiments, the SPRO board 12 can further include transverse stiffeners 20 arranged within the transverse open slots 15T. Similarly, the SPRO board 12 can further include longitudinal stiffeners 22 arranged within the longitudinal open slots 15L. In some embodiments, the SPRO board 12 can include four transverse open slots 15T and four transverse stiffeners 20, and can include three longitudinal open slots 15L and three longitudinal stiffeners 22. A person skilled in the art will understand that more or less stiffeners can be utilized according to the design requirements of the SPRO board 12.

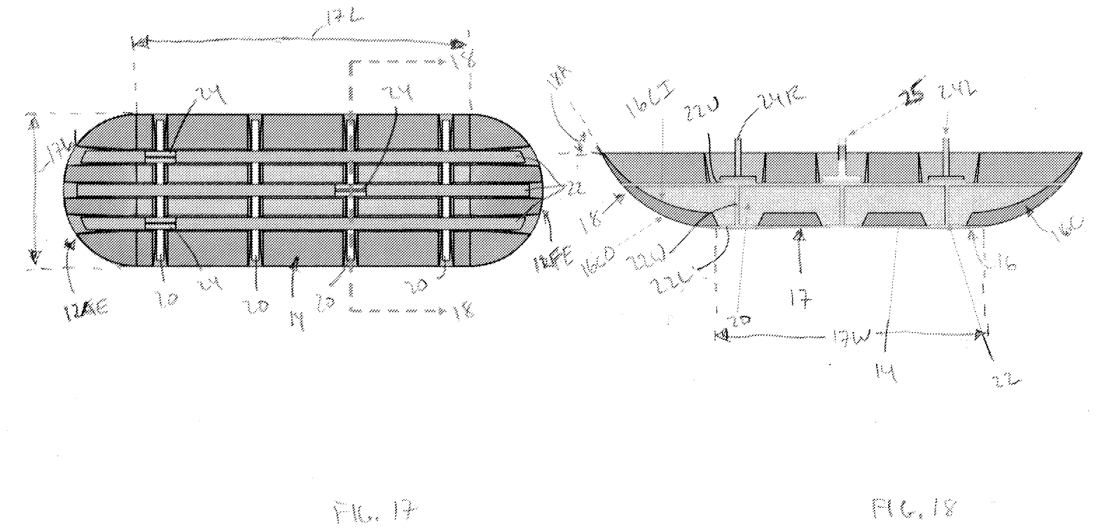

Illustratively, the longitudinal stiffeners 22 can be formed as I-beams having an upper flange 22U, a lower flange 22L, and a beam web 22W extending therebetween, as shown in FIGS. 15 and 18. The lower flange 22L and the beam web 22W of each stiffener 22 can extend through the transverse stiffeners 20 from a forward end 12FE of the board 12 to the opposing aft end 12AE, while the upper flange 22U extends from the forward end 12FE to the aft end 12AE above the transverse stiffeners 20. The SPRO board 12 can further include lug fittings 24L, 24R, 25 arranged on top of the longitudinal stiffeners 22 for pivotably coupling to the first linkage 34 and to the second linkage 38. In some embodiments, the SPRO board 12 includes two aft lug fittings 24L, 24R arranged on the two outer longitudinal stiffeners 22 proximate to the aftmost transverse stiffener 20, also referred to as a first stiffener, and one forward lug fitting 25 arranged on the central longitudinal stiffener 22 proximate to a third transverse stiffener 20, where a second transverse stiffener 20 is arranged between the first and third stiffeners 20. The SPRO board 12 can illustratively include the fourth stiffener 20 as a forwardmost stiffener. In some embodiments, the longitudinal stiffeners 22 are spaced equidistant from each other, and similarly, the transverse stiffeners 20 are spaced equidistant from each other. In some embodiments, the transverse and longitudinal stiffeners 20, 22 can intersect each other at 90 degree angles, as shown in the top-down view of FIG. 17. The foregoing notwithstanding, a person skilled in the art will appreciate other arrangements of the stiffeners 20, 22 that can be made that do not necessarily involve equidistant spacing therebetween. For example, in some instances it may be desirable to have a certain portion of the SPRO board 12 to be stiffer than another portion, e.g., in an instance where a certain portion of the SPRO board 12 may contact a ground surface first, it may be desirable for that portion to have more stiffness than another portion of the SPRO board 12.

By way of non-limiting example, the SPRO board 12 can be fabricated from metallic and/or composite materials. In composite construction embodiments, the SPRO board 12 can be fabricated of a combination of one or more of honeycomb, wood, or foam core material, with one or more of fiberglass, aramid, or carbon fiber face sheets, the combination also being referred to as a composite sandwich panel. In some embodiments, the honeycomb, wood, or foam core can form a core 16C that can be sandwiched between upper and lower face sheets (also referred to as an inner mold line surface 16CI, or an IML 16CI and an opposite outer mold line surface 16CO, or an OML 16CO), thus forming the SPRO board 12. The substantially planar surfaces of the upper and lower face sheets 16CI, 16CO defining the largest cross-sectional area of the sheets can define the “faces” of the sheets, and as shown they can be opposed or substantially opposed to each other. The stiffeners 20, 22 can also be formed of composites in some embodiments, although a person skilled in the art will understand that other materials can be utilized to provide necessary stiffness of the board 12. As described above, the stiffeners 20, 22 can be directly attached to the composite SPRO board inner mold line surface 16CI (opposite the outer mold line surface 16CO) in regions where the core 16C has been panned down by either bonding, fastening or both. A person skilled in the art will appreciate other comparable materials that can be used in lieu of and/or in combination with honeycomb, wood, foam, and/or composite materials.

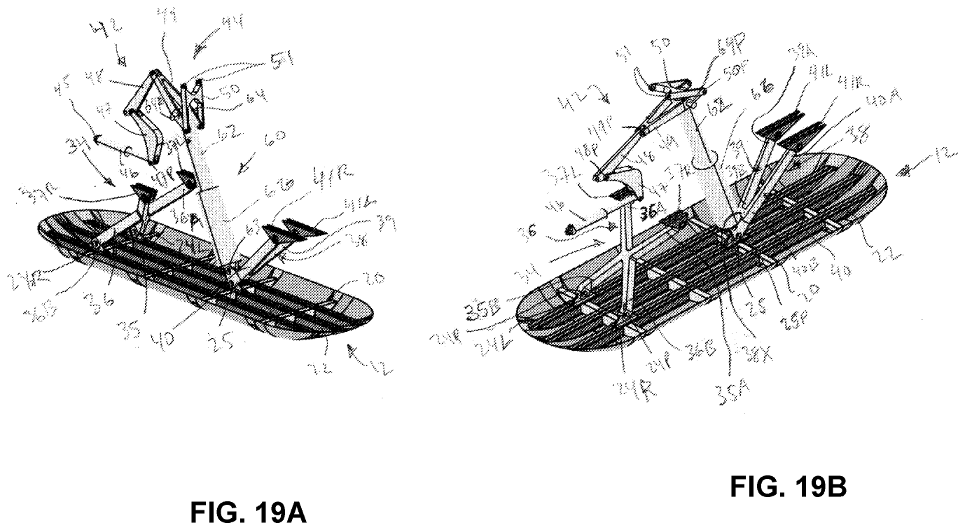

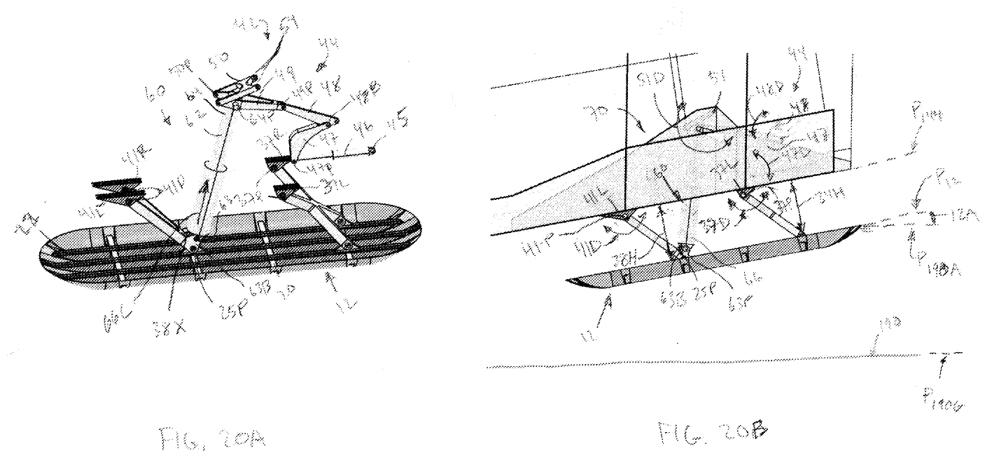

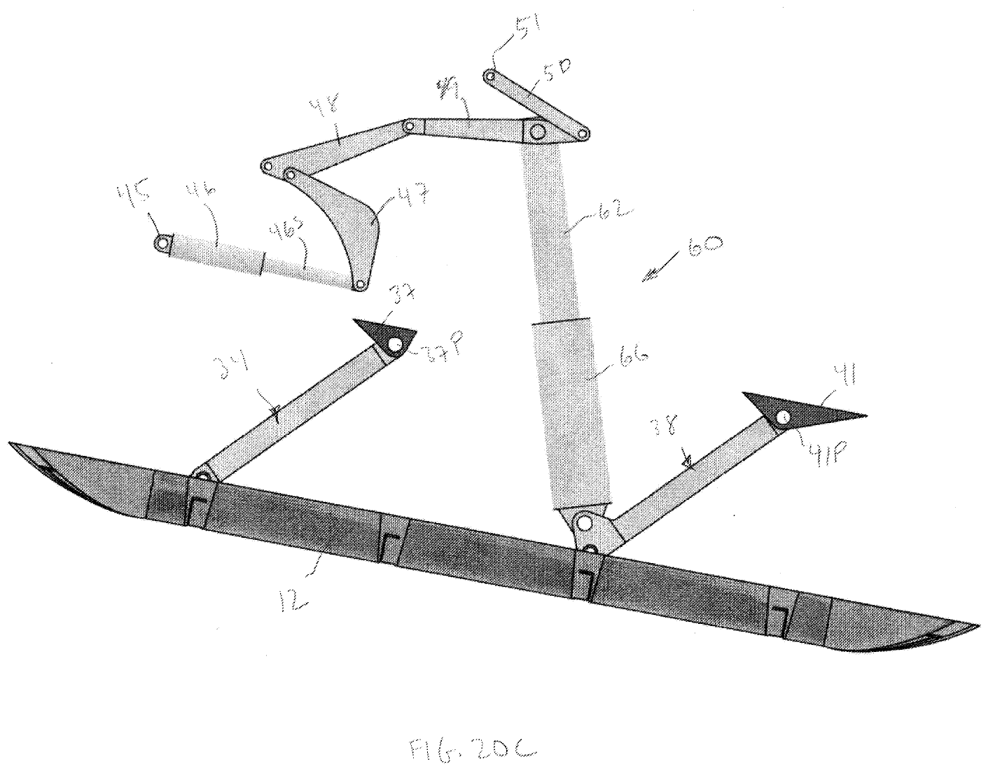

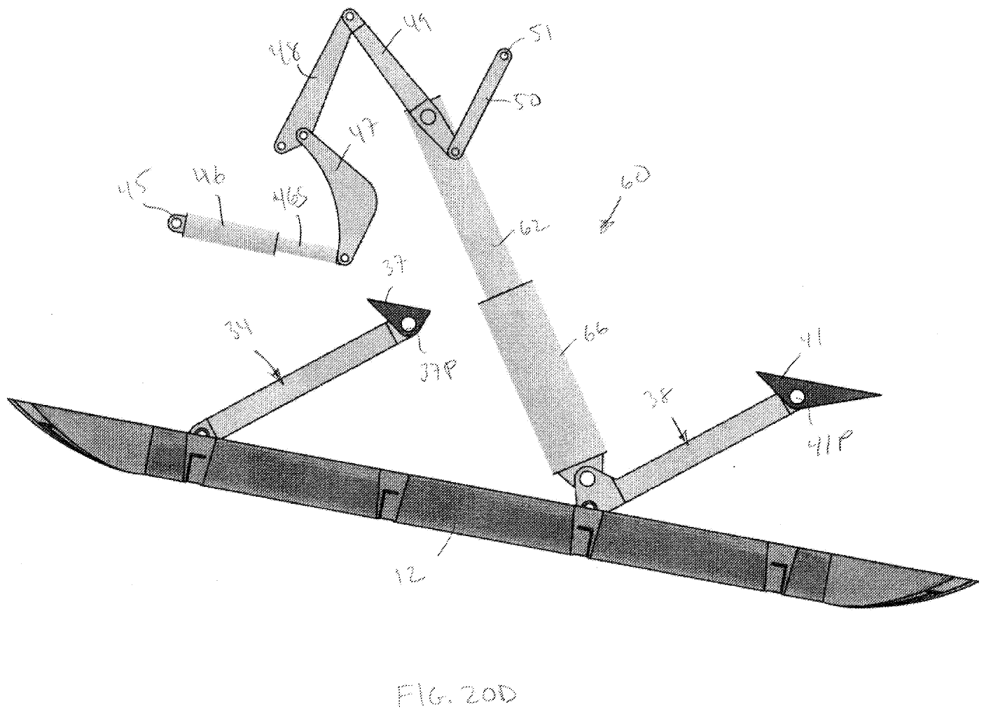

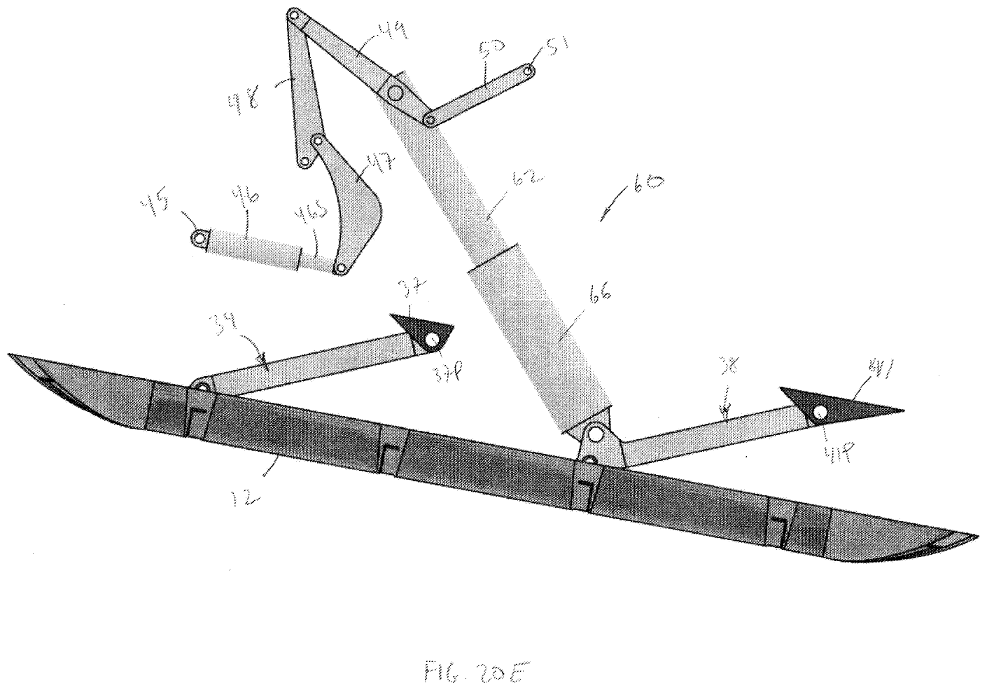

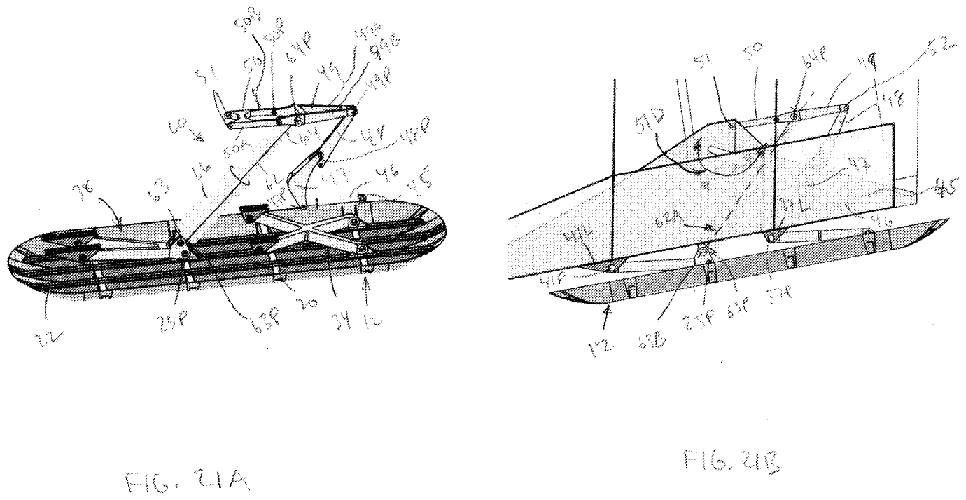

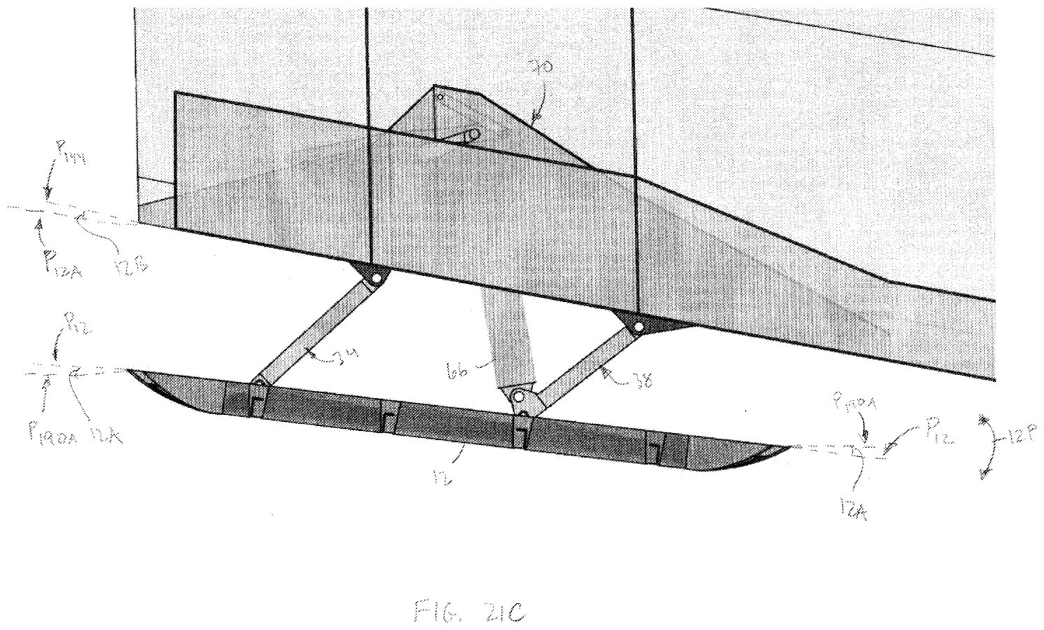

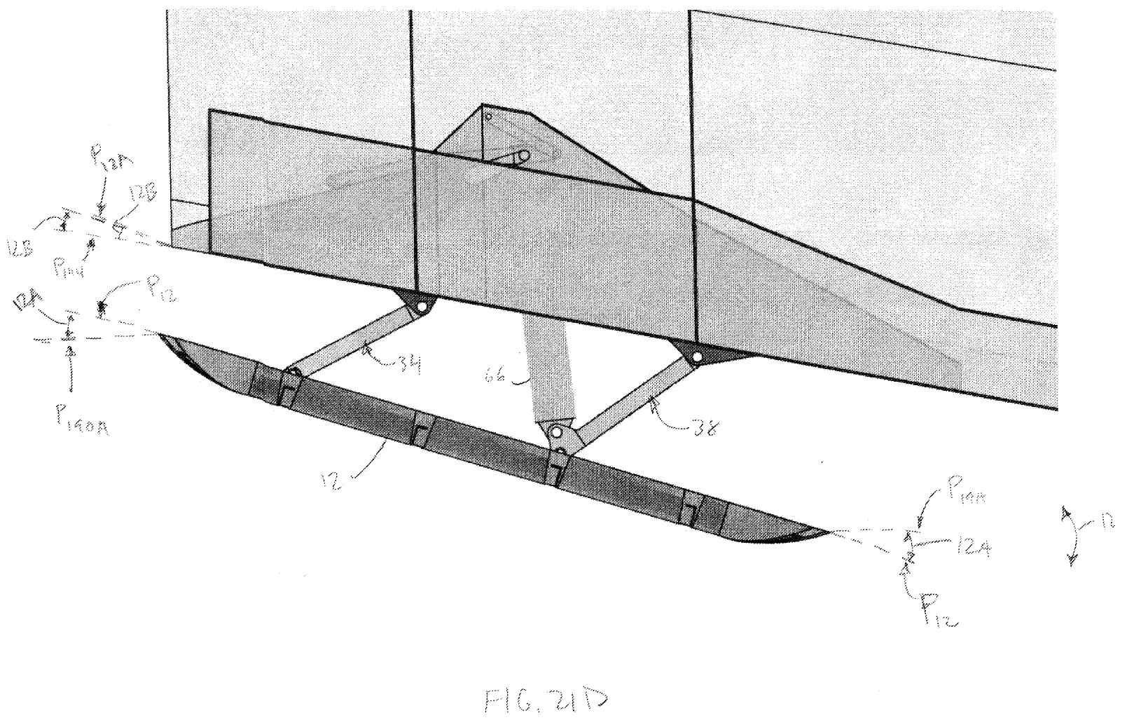

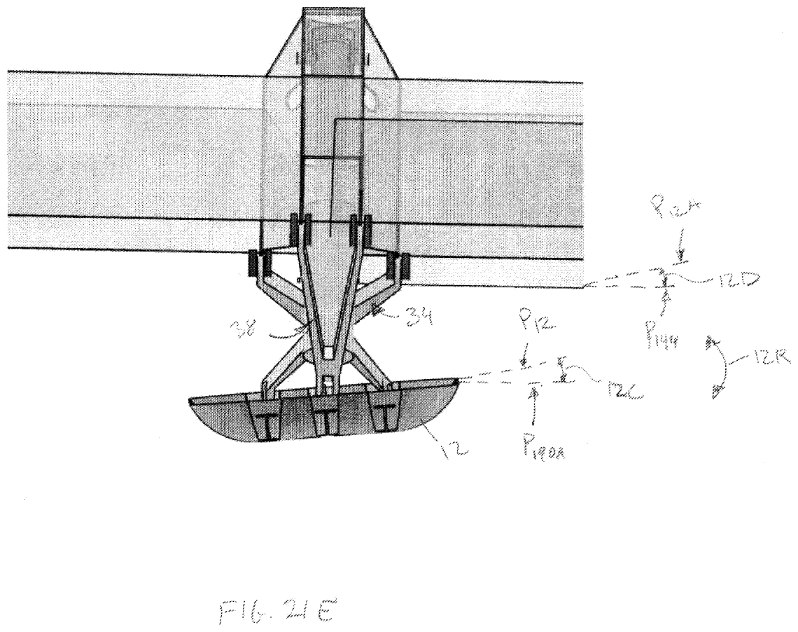

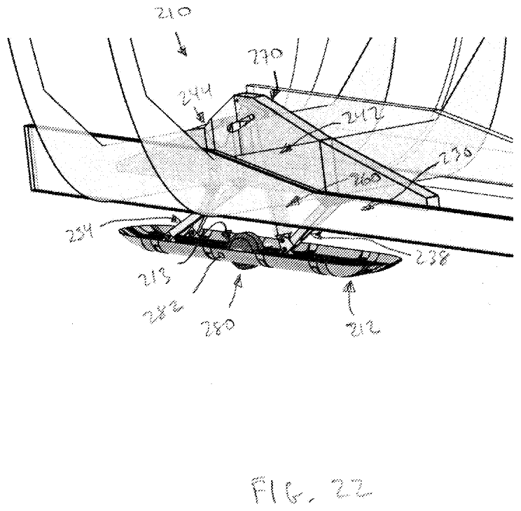

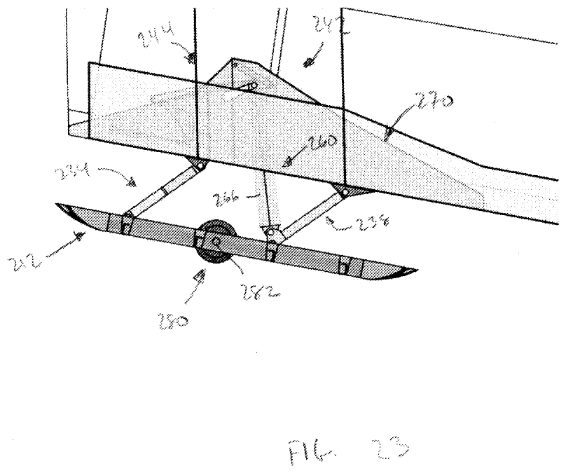

FIGS. 19A-21B show the SPRO board 12 coupled to the retraction system 30 that is configured to move the SPRO board 12 between a deployed position (FIGS. 20A and 20B) and a retracted or stowed position (FIGS. 21A and 21B). The retraction system 30 can include the first or aft linkage 34 and the second or forward linkage 38, each rotatably coupled to the SPRO board 12 at one end of the respective linkages 34, 38 and to the bottom surface 144 of the aft end 140 of the fuselage 101 at the other end of the respective linkages 34, 38. In this way, the retraction system 30 couples the SPRO board 12 to the fuselage 101 of the aircraft 100. In other embodiments, the SPRO board 12 can be coupled to the fuselage 101 by a greater or fewer number of linkages, e.g., a single linkage, three linkages, four linkages, etc., as well as other systems known to those skilled in the art for purposes of deploying and retracting an object. For example, any system known configured to couple to a fixed object and move another object relatively thereto may be utilized to deploy and retract the SPRO board 12 relative to the fuselage 101.

The aft and forward linkages 34, 38 can be configured to rotate about aft and forward lugs 37L, 37R, 41L, 41R coupled to the fuselage 101 along the rotational directions 37D, 41D in a counterclockwise direction, as viewed in FIG. 20B, respectively, so as to move the SPRO board 12 from the deployed position to the retracted position. Similarly, the aft and forward linkages 34, 38 can be configured to rotate about the lugs 37L, 37R, 41L, 41R along the rotational directions 37D, 41D in a clockwise direction, as viewed in FIG. 20B, respectively, so as to move the SPRO board 12 from the retracted position to the deployed position. In some embodiments, the aft and forward linkages 34, 38 can rotate at the same rotational speed such that the aft and forward linkages 34, 38 remain generally parallel to each other throughout the entire movement between the retracted and deployed positions. A person skilled in the art will understand that the linkages 34, 38 can be rotatably coupled to the aircraft 100 via alternative mechanisms, including attachment points located within the fuselage 101 of the aircraft.

The aft linkage 34 can include a first support strut 35 and a second support strut 36, as shown in FIGS. 19A-20A and 21A. A person skilled in the art will understand that, alternatively, the aft linkage 34 can include a single support strut or more than two struts according to the design requirements of the tail strike device 10 and the retraction system 30. In some embodiments, the first and second support struts 35, 36 can be arranged at an angle relative to each other such that the struts 35, 36 intersect to cross each other, for example forming a cross shape.

In the illustrated embodiment, the retraction system 30 can include two aft lugs 37L, 37R arranged on the bottom surface 144 of the aft end 140 of the fuselage 101. The first aft lug 37L, or left lug, can be arranged toward a left side of the fuselage 101 of the aircraft 100, and the second aft lug 37R, or right lug, can be arranged toward the right side of the fuselage 101. The first support strut 35 can have a first end 35A rotatably coupled to the right lug 37R via a pin 37P and a second end 35B opposite the first end 35A and rotatably coupled to the left aft lug 24L via a pin 24P. Similarly, the second support strut 36 can have a first end 36A rotatably coupled to the left lug 37L via a pin 37P and a second end 36B opposite the first end 36A and rotatably coupled to the right aft lug 24R via a pin 24P.

The forward linkage 38 can include a first support strut 39 and a second support strut 40, as shown in FIGS. 19A-20A and 21A. A person skilled in the art will understand that the forward linkage 38 can include a single support strut or more than two struts according to the design requirements of the tail strike device 10 and the retraction system 30. In some embodiments, the first and second support struts 39, 40 can be arranged at an angle relative to each other and can be joined at their second ends 39B, 40B such that the struts 39, 40 intersect at a strut base 38X to form a V-shape.

The retraction system 30 can include two forward lugs 41L, 41R arranged on the bottom surface 144 of the aft end 140 of the fuselage 101, forward of the aft lugs 37L, 37R. The first forward lug 41L, or left lug, can be arranged toward a left side of the fuselage 101 of the aircraft 100, and the second forward lug 41R, or right lug, can be arranged toward the right side of the fuselage 101. The support strut 39 can have a first end 39A rotatably coupled to the left lug 41L via a pin 41P and a second end 39B opposite the first end 39A. Similarly, the second support strut 40 can have a first end 40A rotatably coupled to the right lug 41R via a pin 41P and a second end 40B opposite the first end 40A. The second ends 39B, 40B of the struts 39, 40 can be coupled to each other to form the strut base 38X, the strut base 38X being rotatably coupled to the forward lug 25 via a pin 25P.

As described above, the first and second linkages 34, 38 can be configured to move the SPRO board 12 between a deployed position (FIGS. 20A and 20B) and a retracted position (FIGS. 21A and 21B). The retraction system 30 can further include the upper retraction assembly 42 to move the SPRO board 12 between the deployed and retracted positions. More particularly, the upper retraction assembly can be configured to lift and lower the SPRO board 12 such that it rotates about the lugs 37L, 37R, 41L, 41R and moves between the two positions. Illustratively, the upper retraction system 42 can be coupled to a portion of the aircraft 100 via a first linkage assembly 44 and to the SPRO board 12 via a second linkage assembly 60.

The first linkage assembly 44 can include multiple linkages configured to move and/or rotate relative to each other simultaneously to move the SPRO board 12. In some embodiments, the first linkage assembly 44 can include a first link 46, a first link 47, a second link 48, a third link 49, and a fourth link 50. In other embodiments, the first linkage assembly 44 can include greater or fewer number of links sufficient to move the SPRO board 12, as well as other systems known to those skilled in the art for purposes of deploying, retracting, and/or otherwise positioning an object. The first link 46 can be rigidly coupled at an attachment point 45 to a rigid internal structure (not shown) of the aircraft 100. In some embodiments, as can be seen when comparing FIG. 20B to FIG. 21B, the first link 46 can be coupled to the aircraft 100 so as to remain in a fixed position during movement of the remainder of the first linkage assembly 44.

The remaining links, in particular the first, second, third, and fourth links 47, 48, 49, 50, can be rotatably coupled to each other so as to move in the manner shown in FIGS. 20A-21B. In particular, the first link 46 can be rotatably coupled to the first link 47 at a pivot point 47P, the first link 47 can be rotatably coupled to the second link 48 at a pivot point 48P, the second link 48 can be rotatably coupled to the third link 49 at a pivot point 49P, and the third link 49 can be rotatably coupled to the fourth link 50 at a pivot point 50P. In the deployed position, the links 47, 48, 49, 50 of the first linkage assembly 44 can be positioned in a first arrangement as shown in FIGS. 20A and 20B. In particular, the first link 46 can be fixed and generally parallel with the bottom surface 144 of the fuselage 101, the first link 47 can extend upwardly and aft therefrom, the second link 48 can extend upwardly and forward therefrom, the third link 49 can extend slightly downwardly and forwardly therefrom, and the fourth link 50 can extend upwardly and rearwardly therefrom. The fourth link 50 can rotatably couple to a fixed structure within the aircraft 100 at a coupling point 51, in particular two coupling points 51 in embodiments in which the fourth link 50 includes two coupling arms 50A, 50B. In some embodiments, the third link 49 can also include two arms 49A, 49B that each rotatably couple to the coupling arms 50A, 50B of the fourth link 50.

As shown, the first linkage assembly 44 can be operably coupled to the SPRO board 12 via the second linkage assembly 60. The second linkage assembly 60 can also be referred to as a crush can linkage assembly 60, as the assembly 60 can include a crush can 66, also referred to as a compressible member. The crush can linkage assembly 60 can include a main linkage 62 and a crush can 66 arranged thereon. The main linkage 62 can include a first end 63 arranged proximate to the SPRO board 12 and coupled to the forward lug 25 via a coupling bracket 63B. The first end 63 can be rotatably coupled to the coupling bracket 63 via a pin 63P. The main linkage 62 can further include a second end 64 opposite the first end 63 and arranged proximate to the first linkage assembly 44. In particular, the second end 64 can be rotatably coupled to the third link 49 such that movement of the third link 49 pulls the main linkage 62 and thus the SPRO board 12, upwardly, as will be described below. In some embodiments, the second end 64 of the main linkage 62 can be arranged between the arms 49A, 49B of the third link 49 and can be rotatably coupled to each arm 49A, 49B via a pin 64P.

The main linkage 62 can extend along a longitudinal axis 62A and have a crush can 66 located towards the first end 63. As will be described in detail below, the crush can 66 can compress linearly along the longitudinal axis 62A in a forward direction upon impact of the SPRO board 12 and a landing surface. In the deployed position, the links 49, 50 (as well as the remaining links of the linkage assembly 44) can be locked in position via an actuator 46 or other locking mechanism. As such, the load on the crush can 66C imparted by contact of the SPRO board 12 with the runway 190 can be passed straight into the fuselage 101 via the connection of the fourth link 50 to the fuselage 101 at the coupling points 51. The crush can linkage assembly 60 can be assembled and located such that the crush can 66 can be easily accessed after a tail strike incident. In this manner, an amount of compression or crushing experienced by the crush can 66 can be measured and can represent a magnitude and severity of impact between the tail strike device 10 and the runway 190 or landing surface. The crush can linkage assembly 60 can also serve as a stroking load dampener.

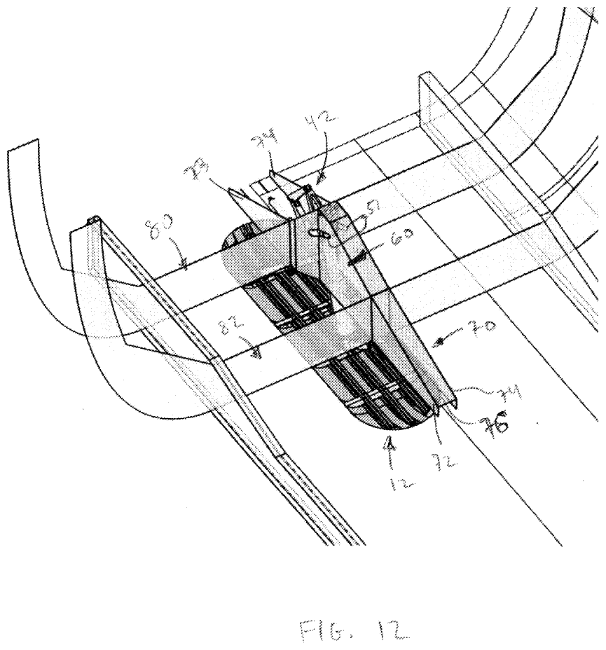

In some embodiments, the tail strike device 10 can further include a cover 70 having generally parallel side walls 72, 74 that can at least partially surround and protect a portion of the upper retraction assembly 42, as shown in FIGS. 11-13. The side walls 72, 74 can be rigidly coupled to the forward spar plane frame 80 and the adjacent aft frame 82. The side walls 72, 74 can each include distal ends 73, 75 located proximate to the aft linkage 34 that are spaced apart further than portions of the side walls 72, 74 located proximate to the forward linkage 38. The extra spacing allows for the aft linkage 34 to be arranged between the distal ends 73, 75 when retracted. The cover 70 may further include a top wall 76 extending between the portions of the side walls 72, 74 located proximate to the forward linkage 38 so as to further protect the forward linkage 38 from damage. In some embodiments, the fourth link 50 can be rotatably coupled to the side walls 72, 74 at the coupling points 51 located on the side walls 72, 74, as shown in FIG. 12. In instances in which the side walls 72, 74 are rigidly coupled to the forward spar plane frame 80 and the adjacent aft frame 82, the side walls 72, 74 can provide ample structural support for the upper retraction assembly 42 to rotate thereabout.

FIGS. 20A and 20B illustrate the tail strike device 10 in a deployed position, i.e., a position in which the SPRO board 12 can be configured to potentially contact a runway 190 or other landing surface to prevent damage to the aft end 140 of the aircraft 100. In some embodiments, the deployed position of the SPRO board 12 is a position of the SPRO board 12 in which the SPRO board 12 is located a first distance from the bottom surface 144 (also referred to as the heights 34H, 38H) at which the SPRO board 12 will prevent the fuselage 101 from contacting the runway 190, or at least minimizing any potential contact, by the SPRO board 12 contacting the runway in response to the attitude of the aircraft 100 being equal to or exceeding a tail strike attitude at which the aft end 140 will strike the runway 190. The tail strike attitude can be defined as an attitude of the aircraft 100, in particular a pitch angle of the aircraft 100 relative to the runway 190 or ground at which the aft end 140 will strike the runway 190 or ground (e.g., θₜₐᵢₗₛₜᵣᵢₖₑ of FIG. 3). In some embodiments, the deployed SPRO board 12 may contact the runway 190 or ground prior to the tail strike attitude being achieved by the aircraft 100. In some embodiments, a pitch angle, or multiple pitch angles, achievable by the tail strike device 10 is approximately in the range of about 0 degrees to about 25 degrees. In at least some instances, the upper retraction assembly 42 can be configured to rotate the tail skid such that the tail skid plane is substantially parallel with the landing surface plane in response to the aircraft being oriented at a level attitude relative to a horizon. Alternatively, or additionally, the retraction assembly can be configured to rotate the tail skid such that the tail skid plane is substantially parallel with the landing surface plane in response to the aircraft being oriented at a first attitude relative to the horizon.

FIGS. 21A and 21B illustrate the tail strike device 10 in a retracted position, i.e., a position in which the SPRO board 12 can be located within close proximity to the fuselage 101, e.g., the airframe, such that drag effects from the SPRO board 12 and tail strike device 10 can be minimized. The tail strike device 10 in the retracted position can protrude or extend only slightly beyond the contour of the fuselage 101. In some embodiments, in the retracted position, the SPRO board 12 can be flush with the bottom surface or belly 144 of the fuselage 101 and contact at least a portion of the bottom surface 144. In still other embodiments, a part or all of the tail strike device 10 can be disposed within the fuselage, similar to the way at least some landing gears are stowed with respect to an aircraft fuselage. The curved edges 18 of the SPRO board 12 can, for example, form or fit into a fairing with the bottom surface 144 of the fuselage 101, which can minimize drag.

In order to move the SPRO board 12 from the deployed position, in which the first linkage assembly 44 is in the first arrangement as shown in FIGS. 20A and 20B, to the retracted position, as shown in FIGS. 21A and 21B, the first linkage assembly 44 can be moved from the first arrangement to a second arrangement, shown, for example, in FIGS. 21A and 21B. Specifically, FIGS. 20C-20E depict the movement of the SPRO board 12 as it moves from the deployed position to the retracted position. During the transition from the first arrangement to the second arrangement, the various links 47, 48, 49, 50 of the first linkage assembly 44 can move and rotate relative to each other simultaneously or substantially simultaneously, and in at least some embodiments, can be moved by an actuator 46, coupled to the fuselage 101 at an attachment point 45. Specifically, during this transition, the first link 47 can rotate relative to the actuator 46 in the counterclockwise direction (when viewed in FIG. 20B) along the rotational direction 47D as the actuator piston 46A moves the first link 47.

The second link 48 can rotate relative to the first link 47 in the clockwise direction (when viewed in FIG. 20B) along the rotational direction 48D, ultimately ending in the position shown in FIG. 21B in which the second link 48 extends in a direction generally aligned with a lengthwise extent of the first link 47. The lengthwise extent of the second link 48 can remain generally aligned with the lengthwise extent of the third link 49 during the transition, as shown in FIGS. 20B-21B. Finally, the fourth link 50 can rotate counterclockwise (when viewed in FIG. 20B) along the rotation direction 51D about the coupling point 51 during the transition such that, in the second arrangement, the lengthwise extent of the fourth link 50 can be generally aligned with the lengthwise extent of the third link 49. Although this transition is described in terms of movement from the first arrangement to the second arrangement, a person skilled in the art will understand that the transition from the second arrangement to the first arrangement occurs in the reverse order as that just described. Likewise, a person skilled in the art will appreciate how other linkage designs, with fewer or more links and/or other components, can be implemented to allow for movement between the retracted and deployed positions without departing from the spirit of the present disclosure.

Although the deployed configuration is illustrated as a singular position, if only because the relevant figures capture a single moment in time, a person skilled in the art will appreciate that the deployed configuration can be one of a plurality of positions or locations at which the SPRO board 12 can be positioned when it is not in the stowed configuration. The present disclosure provides for ways by which the SPRO board 12 can be moved and/or angled with respect to a ground surface, e.g., the runway 190, and/or the aircraft fuselage 101, and can be done so in real-time, by a user and/or a controller as provided for herein, responding to various data inputs received by the user and/or the controller. Thus, the present disclosure accounts for a variety of deployed configurations or positions. Each deployed configuration or position can be considered to be a fixed location at which the tail ski is held steady for possible use to prevent a tailstrike and/or mitigating a tailstrike during a takeoff or landing operation, i.e., to minimize an impact on the aft end of the fuselage due to contacting the landing surface. In fact, as described herein, the deployed configuration can be adjusted to achieve a desired pitch angle for the SPRO board 12, for instance by positioning the SPRO board 12 so that it is substantially parallel to the runway 190 and/or the aft bottom surface 144 in conjunction with performing a takeoff or landing operation.

In some embodiments, the tail strike device 10 can include an actuator 46, actuator system, or other mechanism that can move the tail strike device 10 between the retracted position and the deployed position. By way of non-limiting example, the actuator 46 or actuator system can include a hydraulic actuator that can be controlled with electrical systems routing through the aircraft. Alternatively, or additionally, the actuator can also include one or more pneumatic actuators, electric actuators, mechanical actuators, and/or other actuators known in the art for driving a linkage system, or equivalent of a linkage system when an alternative retractor system is employed. A person skilled in the art will understand how to apply a pivoting mechanism or other actuator to move tail strike devices 10 of the present disclosure from a retracted position to a deployed position. In some embodiments, the actuator 46 can be rotatably coupled to the first linkage assembly 44 at the attachment point 45. The actuator 46 can be configured to pull on the first link 47, thus causing the movement of the various links 47, 48, 49, 50 of the first linkage assembly 44 described above.

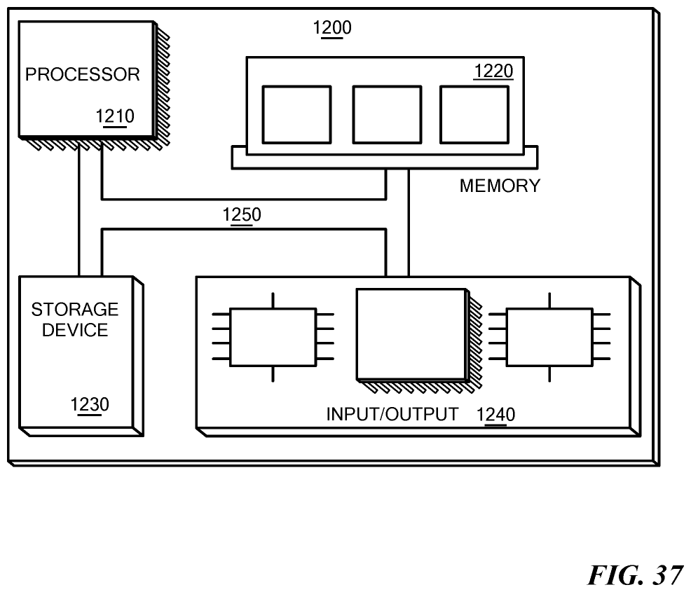

Retracting and deploying the tail strike device 10 can include moving the aft and forward linkages 34, 38 between a generally horizontal orientation, as shown in FIGS. 21A and 21B, to an angled orientation, as shown in FIGS. 20A and 20B. In some embodiments, the tail strike device 10 can be extended into the deployed position automatically, e.g., upon deployment of a landing gear 124 of the aircraft 100, if a rotation of the aircraft 100 or aircraft aft end 140 exceeds a predetermined threshold, etc. The retraction of the tail strike device 10 can also happen automatically in some embodiments, for example, when the aircraft 100 enters a cruise phase of flight. The automation of the deployment and retraction can be controlled by a controller configured to utilize various feedback, sensor data, and the like to determine the desired position of the device 10. The controller can adjust the pitch angle of the tail skid during a takeoff and/or landing operation, thereby assisting in locating or positioning the tail skid at a variety of deployed, fixed positions. The deployed, fixed positions can be pre-programmed such that they are various angles, or they can be adjustable across an entire range of pitch angles, such as approximately in the range of about 0 degrees to about 25 degrees. An exemplary embodiment of a controller is described at the end of this disclosure with respect to FIG. 37. Additionally, or alternatively, the tail strike device 10 can be deployed and retracted manually or semi-automated, meaning utilizing input from a user and a controller or the like. For example, a pilot can depress a button or switch to activate the actuator 46 and deploy or retract the tail strike device 10 can be located in a cockpit of the aircraft 100. The pilot or user may determine that deployment or retraction is necessary based on various factors, such as the user's knowledge of the aircraft 100, terrain factors, flight conditions, operating conditions of the aircraft 100 equipment, feedback from various aircraft 100 sensors, and other information that would inform the pilot or other user whether to deploy or retract the device 10. In other embodiments the tail strike device 10 can be fixed in the deployed position and thus does not require any moving parts and/or systems routing. The tail strike device 10 in the deployed position can protrude from the contour of the fuselage 101 by a much greater distance than the tail strike device 10 in the retracted position. The mechanical layout, i.e., the coupling of the SPRO board 12 to the aircraft 100 and/or the actuator mechanism of the same, of tail strike devices of the present disclosure can vary from the layout of those illustrated in the figures.

In the deployed position, the SPRO board 12 can protrude or extend significantly beyond the bottom surface 144 of the fuselage 101. In some embodiments, the SPRO board 12 can extend approximately at least one meter or more beyond the bottom surface 144 (e.g., several feet). For example, the SPRO board 12 can be located the distance 34H of at least about 20 centimeters, and in some embodiments about 50 centimeters, from the bottom surface 144 at the point where the aft linkage 34 couples to the SPRO board 12 and can be located the distance 38H of at least about 20 centimeters, and in some embodiments about 50 centimeters, from the bottom surface 144 at the point where the forward linkage 38 couples to the SPRO board 12, with each of these distance measurements 34H, 38H taken along a vector extending normal to the bottom surface 144 and the SPRO board 12 when the SPRO board 12 is in the deployed position.

The SPRO board 12 can be oriented in a variety of desired positions relative to the bottom surface 144 of the fuselage 101 and/or to the runway 190 such that a desired predetermined portion of the impact surface 17 of the SPRO board 12 is deployed in a manner to impact the runway 190, the impact surface 17 being defined by a plane P₁₂. Like the deployment and retraction of the tail strike device 10 described above, the adjustment of the orientation of the SPRO board 12 may be executed automatically by aircraft subsystems, manually by the pilot or user based on the information described above, and/or using some combination of the two. By way of non-limiting examples, in the deployed position, the SPRO board 12 can be parallel or substantially parallel to the bottom surface 144 of the fuselage 101, in particular a position in which the plane P₁₄₄ of the bottom surface 144 is parallel or substantially parallel to the plane P₁₂ of the SPRO board 12. In such a position, the angle between the plane P₁₄₄ of the bottom surface 144 and the plane P₁₂ of the SPRO board 12 is approximately 0 degrees.

A person skilled in the art will understand that, in certain scenarios, it may be beneficial to not have the entire impact surface 17 directly contact the runway 190. In some embodiments, as illustratively shown in FIG. 21C, the SPRO board 12 may be oriented such that the forward end 12FE of the board 12 is raised higher than the aft end 12AE and thus the angle 12A, or a desired pitch angle or a first pitch angle, between the plane P₁₉₀ of the runway 190 and the plane P₁₂ of the SPRO board 12 (also shown as P_{12A}) is greater than 0 degrees and/or the angle 12B, or a desired pitch angle or a second or more pitch angles, between the plane P₁₄₄ of the bottom surface 144 and the plane P_{12A} of the SPRO board 12 is greater than 0 degrees. In such an embodiment, the angle 12A between the plane P₁₉₀ of the runway 190 and the plane P₁₂ of the SPRO board 12 and the angle 12B between the plane P₁₄₄ of the bottom surface 144 and the plane P_{12A} of the SPRO board 12 can be approximately in the range of about 0 degrees to about 25 degrees, and in some embodiments, the angle can be approximately in the range of about 0 degrees to about 10 degrees, and in some embodiments, between 0 degrees and 5 degrees. A person skilled in the art will understand that these angles can be negative as well depending on the direction of measurement. In other embodiments, as shown in FIG. 21D, the SPRO board 12 may be oriented such that the aft end 12AE of the board 12 is raised higher than the forward end 12FE, and similar angles as described above regarding the forward end 12FE being higher than the aft end 12AE can be utilized. In order to move the forward and aft ends 12FE, 12AE relative to each other such that the SPRO board 12 is not parallel with the bottom surface 144, a person skilled in the art will understand that additional actuators, for example attached to one or more of the lugs 24L, 24R, 25, may be utilized to move one of the linkages 34, 38 more so than the other linkage 34, 38 when the SPRO board 12 is moved between the retracted and deployed positions. For example, in some embodiments, these angles can be achieved via springs, bands, cables, and similar devices.

Alternatively or additionally, the SPRO board 12 can be oriented based on a desired angle relative to the runway 190 or landing surface as opposed to a desired angle relative to the bottom surface 144. Specifically, the SPRO board 12 may be oriented such that a desired board to runway angle 12A can be achieved, the board to runway angle 12A being defined between the plane P₁₂ of the SPRO board 12 and a plane P_{190A} that is parallel to the ground plane P_{190G}. For example, as shown in FIG. 20B, the SPRO board 12 is oriented substantially parallel with the bottom surface 144 so as to define a board to runway angle 12 of greater than 0 degrees, in particular an angle equal to the angle of the bottom surface 144 of the fuselage 101 relative to the runway 190. In some embodiments, the SPRO board 12 deployment orientation can be adjusted, via additional actuators as described above, to achieve a desired board to runway angle 12A.

In some embodiments, the SPRO board 12 can be oriented at an angle relative to the bottom surface 144 such that the plane P₁₂ is parallel with the plane P_{190A} while the aircraft 100 is in a nose-up position. In some embodiments, the aircraft 100 can be in a nose-up position that causes the aft end 140 of the fuselage 101 to be oriented relative to the runway 190 at an angle that is less than the starting angle of the aft end 140 during level travel of the aircraft 100. In such an embodiment, the SPRO board 12 can be configured to be oriented such that the plane P₁₂ remains parallel or substantially parallel with the plane P_{190A}. In some embodiments, for example during a landing maneuver, the aircraft 100 can be in an extreme nose-up position that can cause the aft end 140 of the fuselage 101 to be oriented relative to the runway 190 at an angle that locates the rearmost area of the aft end 140 to be closer to the runway 190 than the forwardmost area of the aft end 140 closest to the landing gear 124. In such an embodiment, the SPRO board 12 can be configured to be oriented such that the plane P₁₂ remains parallel or substantially parallel with the plane P_{190A}. In some embodiments in which the orientation of the SPRO board 12 is automated, a controller may be configured to rotate and then hold the SPRO board 12 at a certain position, or may be configured to continuously adjust the SPRO board 12 such that the pitch angle 12A, 12B of the SPRO board 12 remains at a desired orientation while the aircraft 100 changes attitude, such as, by way of example, keeping the plane P₁₂ parallel or substantially parallel with the plane P_{190A}. In some embodiments, the pitch angle may be first adjusted to a first pitch angle, and then subsequently adjusted to a second pitch angle, a third pitch angle, and so on.

In some embodiments, the roll axis of the SPRO board 12 can be adjusted in view of particular operating condition, aircraft 100 pitch angle (attitude), aircraft 100 roll angle, and/or aircraft 100 yaw angle, as shown in FIG. 21E. In particular, the SPRO board, 12 can be adjusted along the roll rotational direction 12R via additional actuators, springs, and/or similar devices as described above and/or known to those skilled in the art, which can be movably coupled to and/or between the lower ends of the linkages 34, 38 and the SPRO board 12. In other embodiments, the struts 35, 36, 39, 40 of the linkages 34, 38 can be adjustable to provide for roll axis adjustment of the SPRO board 12. As illustratively shown in FIG. 21E, the SPRO board 12 can be oriented to such that a roll angle 12C, or a desired roll angle or a first roll angle, as measured between the plane P₁₂ of the SPRO board 12 and the plane P_{190A} of the runway 190 and/or a roll angle 12D, or a desired roll angle or a second roll angle, as measured between the plane P_{12A} parallel to the SPRO board 12 and the plane P₁₄₄ of the bottom surface 144, is greater than 0 degrees, in particular approximately 10 degrees in at least some embodiments. In some embodiments, the angles 12C, 12D can be approximately in the range of about 0 degrees to about 25 degrees, and in some embodiments approximately in the range of about 0 degrees to about 10 degrees, and in some embodiments approximately in the range of about 0 degrees to about 5 degrees. In this way, in lieu of or combined with the adjustable pitch angle of the SPRO board 12, the SPRO board 12 can be configured to achieve a plurality of deployed, fixed positions for contacting the landing surface 192 of the runway 190 to minimize an impact on the aft end 140 of the fuselage 101 due to contacting the landing surface 192. A person skilled in the art will understand that these angles can be negative as well depending on the direction of measurement. In some embodiments in which the orientation of the SPRO board 12 is automated, a controller can be configured to rotate and then hold the SPRO board 12 at a certain position about the roll axis, and/or can be configured to continuously adjust the roll angle 12C, 12D of the SPRO board 12 such that the SPRO board 12 remains at a desired orientation while the aircraft 100 changes attitude, such as, by way of example, keeping the plane P₁₂ parallel or substantially parallel with the plane P_{190A}. In some embodiments, the roll angle can be first adjusted to a first roll angle, and then subsequently adjusted to a second roll angle, a third roll angle, and so on.

A person skilled in the art will understand that the controller described herein can be configured to control the pitch and roll angles described above, as well as other aspects of the SPRO board (e.g., yaw, length, width, thickness, etc., as provided for in greater detail below). The controller can be configured to receive one or more data inputs and adjust at least one of the pitch angle or the roll angle in response to the same. In such embodiments, the controller is configured to adjust at least one of the pitch angle or the roll angle automatically in response to the one or more received data inputs.

In these or other embodiments, the SPRO board 12 may be adjustable in other manners. In one embodiment, the SPRO board 12 may additionally be adjusted about its yaw axis, or an axis that is perpendicular to the central longitudinal axis of the SPRO board 12 and extends upwardly toward the fuselage 101. In one non-limiting exemplary embodiment, the dimensions of the SPRO board 12, such as the length and the width, can be adjustable. That is, having a longer, shorter, wider, or less side SPRO board may be desirable in view of certain contains. By way of non-limiting example, the outer sides of the SPRO board 12 can be configured to extend outwardly away from the center of the SPRO board 12 so as to increase the surface area of the bottom of the SPRO board 12, in particular the impact surface 17, and/or may be configured to retract before or after extending in order to reduce the surface area back to its original dimensions or to even smaller than the original dimensions. In other instances, structures forming the SPRO board can be telescoping with respect to each other and/or can otherwise have the ability to be selective lengthened and shortened as desired. A person skilled in the art will understand that additional mechanical, electrical, hydraulic, and/or similar components, including movable side walls that can extend and retract via actuators or the like, may be utilized to provide such a dimension adjustable SPRO board 12.

### Further Embodiments of a Tail Strike Device

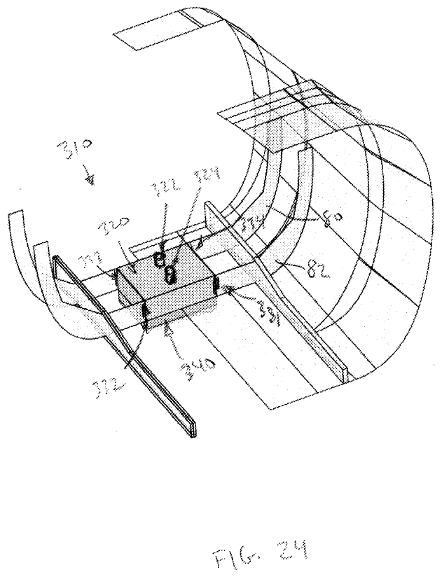

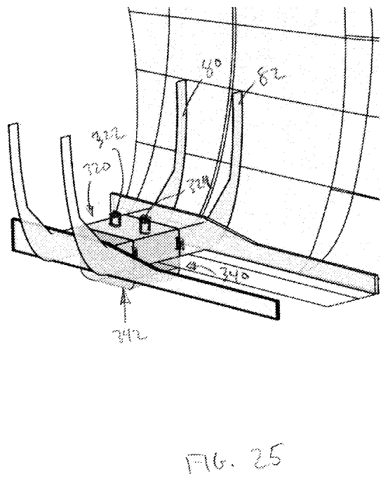

Another embodiment of a tail strike device 210 in accordance with the present disclosure is shown in FIGS. 22 and 23. The tail strike device 210 is substantially similar to the tail strike device 10 described herein. Accordingly, similar reference numbers in the 200 series indicate features that are common between the tail strike device 210 and the tail strike device 10. The description of the tail strike device 10 is incorporated by reference to apply to the tail strike device 210, except in instances when it conflicts with the specific description and the drawings of the tail strike device 210. Any combination of the components of the tail strike device 10 and the tail strike device 210 described in further detail below may be utilized in an assembly of the present disclosure.

The tail strike device 210 includes similar components to the tail strike device 10, including a SPRO board 212, a retraction system 230 including first and second linkages 234, 238, and an upper retraction assembly 242, as shown in FIGS. 22 and 23. The upper retraction assembly 242 includes first and second linkage assemblies 244, 260. The second linkage assembly 260 can include a crush can 266. A cover 270 can be included to protect the upper retraction assembly 242 from damage.

Unlike the SPRO board 12, the SPRO board 212 of the tail strike device 210 can include a tire or wheel 280. In the illustrated embodiment, the wheel 280 is arranged in a central opening 213 formed in the SPRO board 212, as shown in FIGS. 22 and 23, although other locations across the length and/or width of the SPRO board 212 are possible. The wheel 280 can be rotatably coupled to the SPRO board 212 about a rotation axis 282 via a pin or other rotatable member. Including the wheel 280 on the SPRO board 212 can be advantageous in that the wheel 280 can contact the runway before the remainder of the SPRO board 212, thus preventing some damage to the SPRO board 212 from occurring. Such prevention may be particularly beneficial when the aircraft 100 is landing on a paved runway. In some embodiments, the second linkage assembly 260 can be coupled to the pin supporting the wheel 280. Thus, in some such embodiments, the second linkage assembly 260 may absorb some of the impact forces experienced by the wheel 280 during impact. In some embodiments, the second linkage assembly 260 can include a swivel coupled to the wheel 280. The swivel can aid the wheel 280 in absorbing load upon contact with the runway.

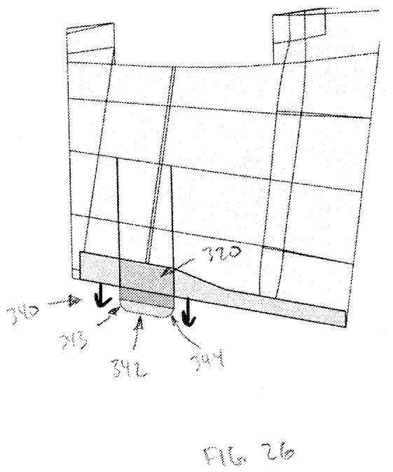

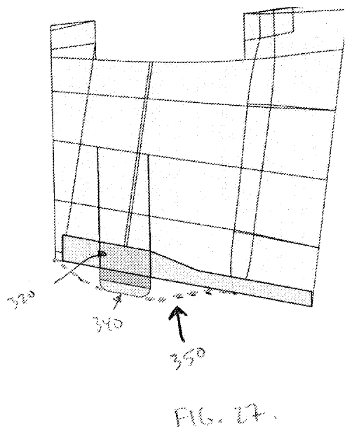

Another embodiment of a tail strike device 310 in accordance with the present disclosure is shown in FIGS. 24-27. In this embodiment, the tail strike device 310 does not include a SPRO board similar to the SPRO boards 12, 212 described herein, but instead includes an air bag 340 configured to prevent the fuselage 101 from impacting the runway during nose-up maneuvers of the aircraft 100. As shown, the air bag 340, which in alternative embodiments can be a plurality of air bags, can include a bottom surface 342 and forward and aft curved surfaces 343, 344. The airbag 340 may be coupled to an interior housing 320 that can be fixedly coupled to the frames 80, 82 at attachment points 331, 332, 333, 334. The interior housing 320 can include an inner chamber that can be fluidically connected to the interior of the air bag 340. The interior housing 320 can thus be configured to supply fluid, in particular air, to the air bag 340 for inflation, and receive air from the air bag 340 when the air bag 340 is deflated immediately prior to and/or during impact. The interior housing 320 can include first and second relief valves 322, 324, which can be configured to control compression of the air bag 340, similarly to a shock absorber.

In some embodiments, the air bag 340 can be inflated prior to a potential tail strike impact. Thus, the air bag 340 can contact the runway prior to aft end 140 of the fuselage 101. After contact with the runway, the air bag 340 can deflate, thus absorbing the forces of the impact. In some embodiments, the air bag 340 can be configured to rapidly expand just before a potential impact or when in close proximity with the runway so as to allow the air bag 340 to remain in a stowed position within the fuselage 101 or near the bottom surface 144 until just before an impact with the runway. In some embodiments, the device 310 may further include a fairing 350 attached to the bottom surface 144 and surrounding the air bag 340, the fairing 350 configured to reduce drag during cruise that may be caused by the air bag 340. In some embodiments, the airbag 340 can be deployed automatically, e.g., when the aircraft 100 rotates beyond a pre-determined amount. In some embodiments, the tail strike device 310 may also include a SPRO board in addition to the airbag 340, the SPRO board spaced apart from the air bag 340 at a location on the bottom surface 144 of the aft end 140 of the fuselage 101.

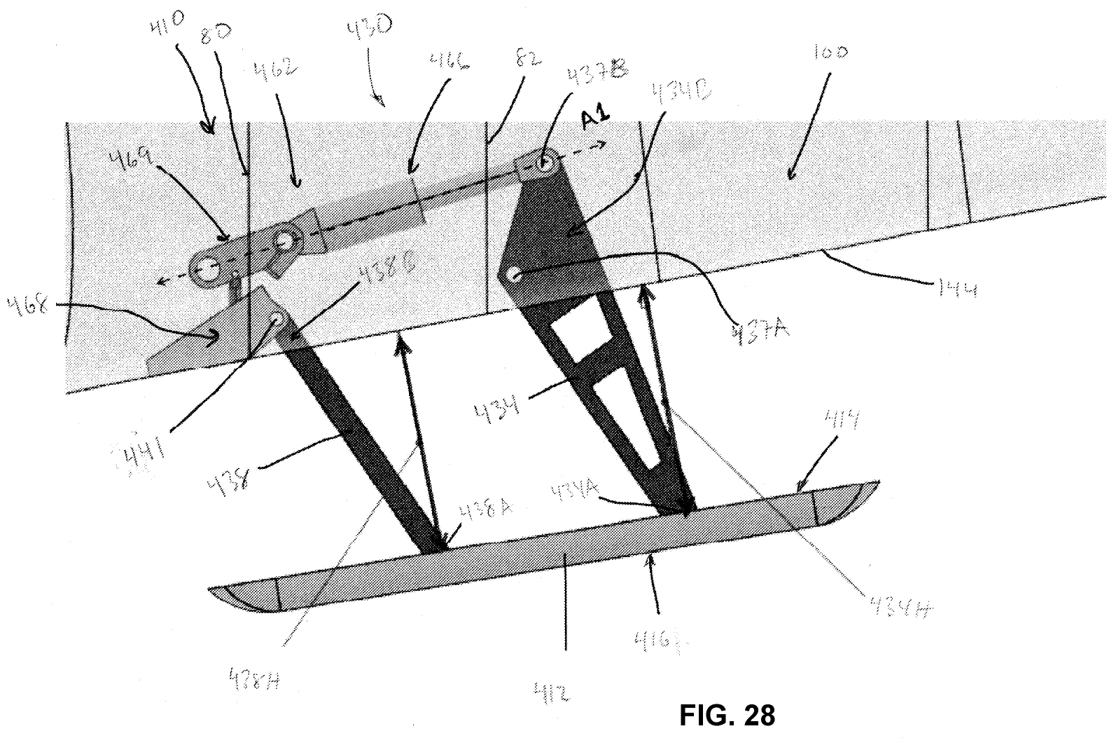

Another embodiment of a tail strike device 410 in accordance with the present disclosure is shown in FIGS. 28-32. The tail strike device 410 is substantially similar to the tail strike devices 10, 210 described herein. Accordingly, similar reference numbers in the 400 series indicate features that are common between the tail strike device 410 and the tail strike devices 10, 210. The descriptions of the tail strike devices 10, 210 are incorporated by reference to apply to the tail strike device 410, except in instances when it conflicts with the specific description and the drawings of the tail strike device 410. Any combination of the components of the tail strike device 10, 210 and the tail strike device 410 described in further detail below may be utilized in an assembly of the present disclosure.

FIGS. 28-32 illustrate the tail strike device 410 of the aircraft 100. The tail strike device 10 can extend from the bottom surface or belly 144 of the aft end 140 of the fuselage 101 of the aircraft 100 generally proximate to an area substantially underneath the tail or empennage 150 of the aircraft 100. A tail skid, or SPRO board, 412 of the tail strike device 410 can be located substantially underneath the empennage 150. The tail strike device 410 can attach to a forward spar plane frame 82 (see FIG. 28) of a horizontal stabilizer and adjacent aft frame(s) 80 (see FIG. 28).

FIG. 28 illustrates one embodiment of the tail strike device 410 of the aircraft 100. More particularly, FIG. 28 shows the tail strike device 410 protruding or extending from the bottom surface or belly 144 of the airframe, as shown the aft end 140 of the fuselage 101, in a deployed position, i.e., a position to mitigate a tail strike incident. The tail strike device 410 can include a SPRO board 412 that can have an upper layer or surface 414 and a lower layer or surface 416. The lower surface 416, in particular a planar bottom surface 17 (also referred to as an impact surface), can be configured to contact the runway or a landing surface in the event of a potential tail strike, which can occur, for example, due to over-rotation of the aircraft during takeoff or landing. The lower surface 416 can be a high flotation impact surface such that the SPRO board 412 can skim or skid over the runway or landing surface, even when the runway is semi-prepared, e.g., not fully paved. The SPRO board 412 can be coupled to the aircraft 100 by a retraction system 430, which can include the linkages 434, 438, the crush can linkage 462, the crush can 466, the contact fitting 468, and the link 469.

One non-limiting example of a retraction system is illustrated by a first or aft linkage 434 and a second or forward linkage 434. The first linkage 434 can have a first end 434A coupled to the SPRO board 412 and a second end 434B coupled to the fuselage 101 by a first pin 437A. A first end 438A of the second linkage 438 can be coupled to the SPRO board 412 at a second location that can be forward of the first location and a second end 438B of the second linkage 438 can be coupled to the fuselage 101 by a second pin 441. Accordingly, the first linkage 434 may be referred to as an aft linkage or aft arm and the second linkage 438 may be referred to as a forward linkage or a forward arm. In this way, the retraction system 430 couples the SPRO board 412 to the fuselage 101 of the aircraft 100. In other embodiments, the SPRO board 412 can be coupled to the fuselage 101 by a greater or fewer number of linkages, e.g., a single linkage, three linkages, four linkages, etc., as well as other systems known to those skilled in the art for purposes of deploying and retracting an object.

A crush can linkage 462 can be located within the fuselage 101 of the aircraft 100, such as within the airframe, and can couple the first linkage 434 and the second linkage 438. An aft end of the crush can linkage 462 can be coupled to the second end 434B of the first linkage 434 by a third pin 437B. A forward end of the crush can linkage 462 can be coupled to the second end 438B of the second linkage 438 through a contact connection 468 and a link 469 that can extend along a longitudinal axis A1 of the crush can linkage 462 when the tail strike device 410 is in the deployed position. As provided for herein, in at least some embodiments the tail strike device 410 can be movable between a retracted position and a deployed position. In some such embodiments, the link 469 can pivot from the deployed position, as shown in FIG. 28, to a retracted position in which the link 469 extends at an oblique angle or substantially perpendicular to the longitudinal axis A1 of the crush can linkage 462. The coupling between the crush can linkage 462 and the first and second linkages 434, 438 can facilitate deployment and retraction of the tail strike device 410. The crush can linkage 462 can extend along a longitudinal axis A1 and have a crush can 466 located towards a forward end of the linkage. As will be described in detail below, the crush can 466 can compress linearly along the longitudinal axis A1 in a forward direction upon impact of the SPRO board 412 and a landing surface. The crush can linkage 462 can be assembled and located such that the crush can 466 can be easily accessed after a tail strike incident. In this manner, an amount of compression or crushing experienced by the crush can 466 can be measured and can represent a magnitude and severity of impact between the tail strike device 410 and the runway or landing surface. The crush can linkage 462 can also serve as a stroking load dampener.

In the deployed position, the SPRO board 412 can protrude or extend significantly beyond the bottom surface or belly 144 of the airframe, e.g., the aft end 140 of the fuselage 101. In some embodiments, the SPRO board 412 can extend approximately at least one meter or more beyond the bottom surface 144 (e.g., several feet). For example, the SPRO board 412 can be located a distance 434H of at least about 84 centimeters from the bottom surface 144 of the fuselage 101 at the point where the first linkage 434 couples to the SPRO board 412 and can be located a distance 438H of at least about 86.5 centimeters from the bottom surface 144 of the fuselage 101 at the point where the second linkage 438 couples to the SPRO board 412, with each of these distance measurements 434H, 438H taken along a vector extending normal to the fuselage 101 and the SPRO board 412 when the SPRO board 412 is in the deployed position. The SPRO board 412 can be oriented parallel or substantially parallel to the bottom surface 144 of the fuselage 101 in the deployed position.

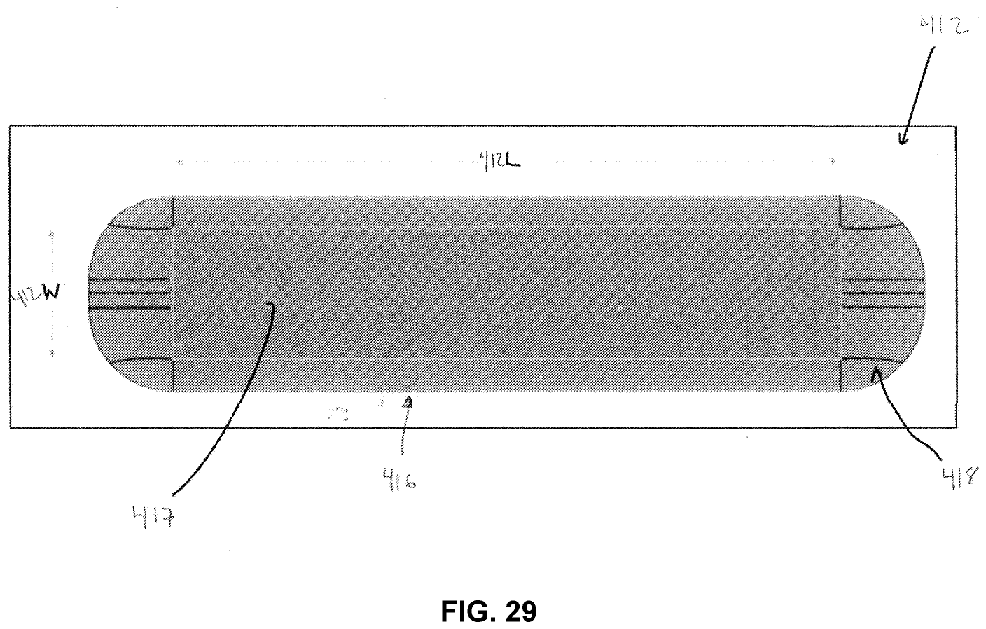

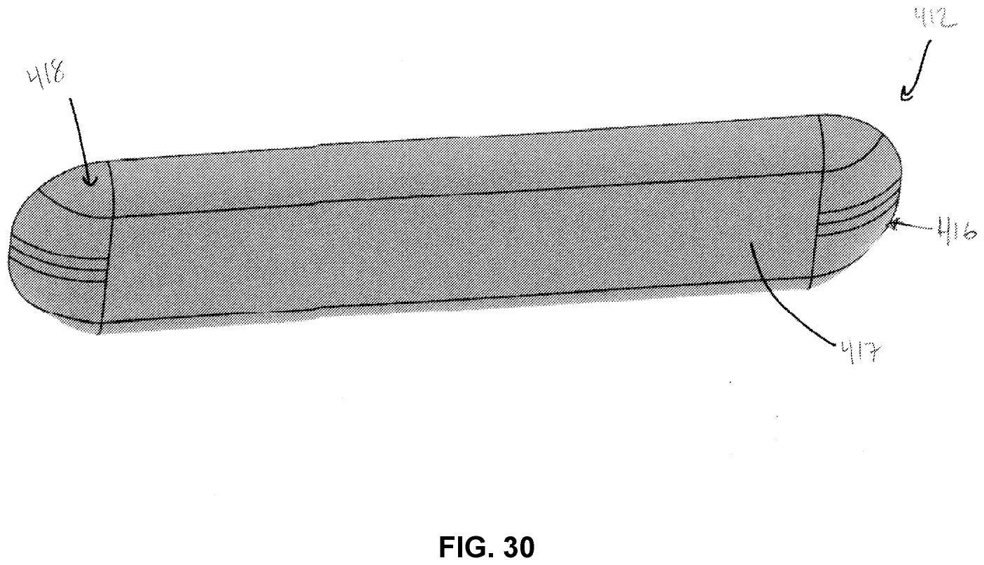

FIGS. 29 and 30 illustrate one embodiment of the SPRO board 412 in a bottom-up plan view and a perspective view, respectively. The SPRO board 412 can serve as a high flotation impact surface 417 such that the SPRO board 412 can skim or skid across a semi-prepared runway 190 without rutting or gouging into the runway 190. Moreover, the SPRO board 412 can be constructed such that predictable loads can be transmitted to the aircraft upon contact of the SPRO board 412 with the runway. Because SPRO boards of the present disclosure can travel across a semi-prepared runway surface 192 without rutting, harm to the runway 190 can be avoided and damage to the aircraft 100 can be mitigated by reducing or removing unpredictability of the loads. In some embodiments, the SPRO board 412 can resemble a ski or a sled. The bottom surface 412b of the tail ski 412 can be a generally planar surface that can be designed to contact and skid over the runway. For example, the bottom surface 412b of the SPRO board 412 can be an elongated rectangle with a length 412L that can be larger than a width 412W. The bottom surface 417 of the SPRO board 412 (also referred to herein as an impact surface or contact surface) can be sized to exert a pressure on the runway that is equal to or less than a maximum pressure exerted on a runway by landing gear tires 124 under their highest vertical load case, e.g., during a three point (“3 Pt.”) sudden braked roll ground load case where there are only three points of contact being made, such as when there is a roll of the plane due to high winds or the like. By way of non-limiting examples, the SPRO board 412 can have an impact surface area of at least about 1290 cm², at least about 2000 cm², greater than about 4000 cm², at least about 6000 cm², at least about 7000 cm², or at least about 7740 cm². In one embodiment, the SPRO board 412 can have an impact surface area 417 of about 2800 cm². For example, the impact surface area 417 can have a length L of about 119 cm and a width of about 24 cm. The other dimensions described above with respect to the SPRO board 12 are also applicable to the SPRO board 412, and other SPRO board (e.g., the SPRO board 212) configurations provided for herein. SPRO board 412 can have radial fillet curved edges 418 that can surround the impact surface 417. The curvature to the edges 418 of the SPRO board 412 can enable the SPRO board 412 to skid over the runway 190 without catching or rutting into the runway surface 192, including a semi-prepared runway 190 that can include more uneven and/or softer surface 192 than a paved runway 190. By way of non-limiting example, the SPRO board 412 can be a high strength metallic or composite material, or as a sandwiched material having an upper layer of honeycomb, wood, or foam material and a lower layer of composites.

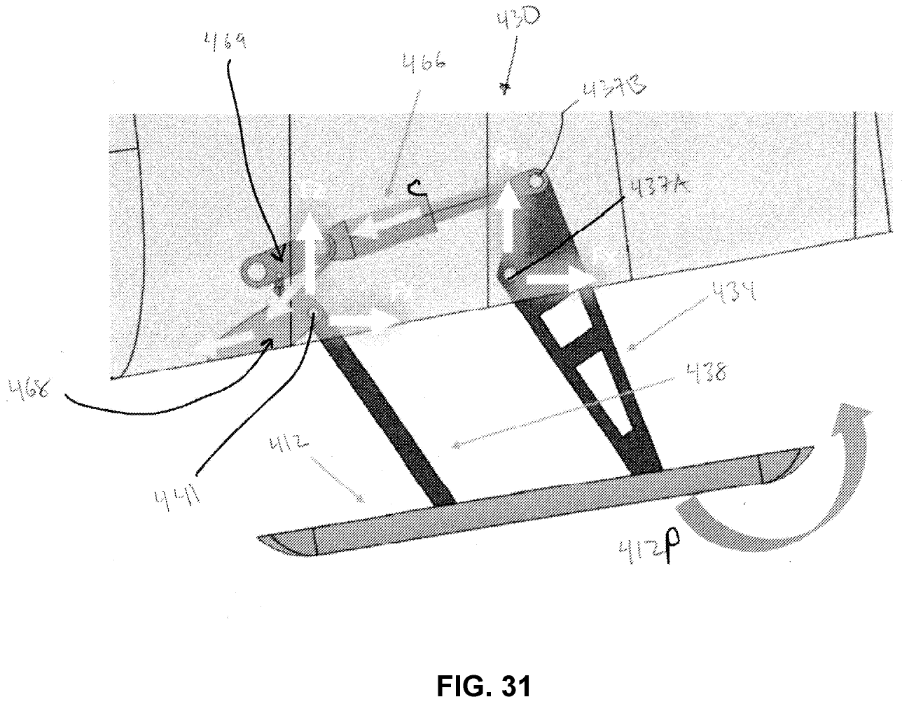

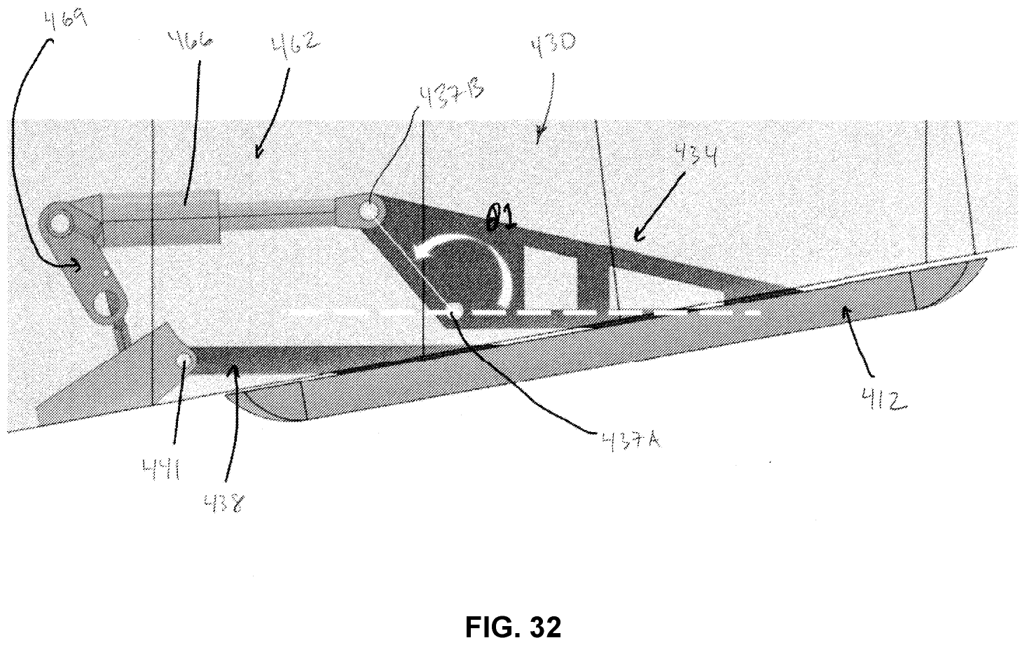

As noted above, in some embodiments the tail strike device 410 can be retractable and can be moved between a deployed position, e.g., as shown in FIG. 28, and a retracted position, e.g., as shown in FIG. 32. FIG. 31 illustrates one embodiment of a mechanism that can deploy and retract the tail strike device 410 that can include an actuator 469 that can cause the first and second linkages 434, 438 to pivot about pins 437A, 441 to extend the SPRO board 412 away from the bottom surface or belly 144 of the fuselage 101. FIG. 31 further illustrates a force diagram of loads imparted onto components of the tail strike device 410 and fuselage 101 during contact between the SPRO board 412 and a runway.

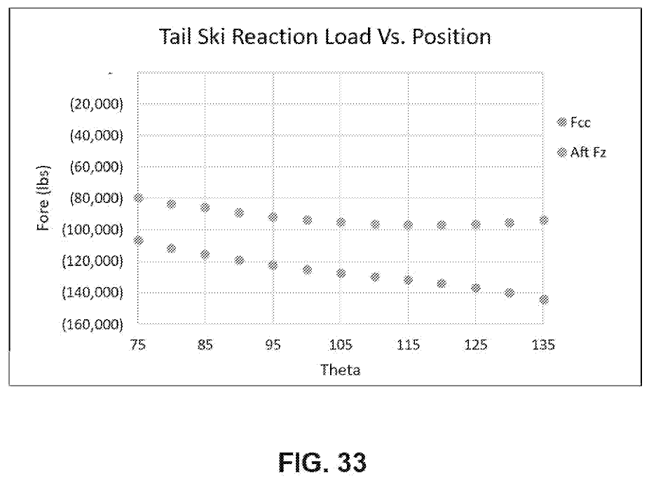

With the SPRO board 412 in the fully deployed position, the crush can 466 can connect to the contact fitting 468. This can allow load on the crush can Fcc imparted by contact of the SPRO board 412 with the runway to bypass the actuator 469 and be passed straight into the fuselage 101. With contact between the SPRO board 412 and the runway, the crush can 466 can be compressed or crushed in the forward direction along its longitudinal axis (see arrow 410C in FIG. 31) and the SPRO board 412 can pivot (see arrow 412P in FIG. 31) about the two pins 437A, 441 coupling the first and second linkages 434, 438 to the fuselage 101. The two pins 437A, 441 can be oriented along a y-axis, which can be in a direction that extends perpendicularly into and out of the page of FIG. 31. As the SPRO board 412 pivots about the Y-oriented pins 437A, 441 the SPRO board 412 can rest along the bottom surface 144 of the fuselage 101 over a stroke length. FIG. 33 plots the vertical reaction load at the aft swing arm 434, pin 437A, and the axial crush-can load Fcc on the crush can 466 as a function of rotational position θ1 (see FIG. 32) of the tail strike device 410 from a fully extended or deployed position (θ1 equals about 75 degrees) to a fully retracted or compressed position (θ1 equals about 135 degrees) in one embodiment of the tail strike device 410. As shown, the aft swing arm (“Aft Fz” data points) demonstrates a higher vertical reaction load at each retracted/compresses position than the axial crush-can (“Fcc” data points) (e.g., at 75 θ, the vertical reaction load is about 80,000 for the axial crush-can and over 410,000 for the aft swing arm).

FIG. 32 illustrates the tail strike device 410 in a retracted position, e.g., a position in which the SPRO board 412 can be located within close proximity to the fuselage 101 such that drag effects from the SPRO board 412 and tail strike device 410 can be minimized. The tail strike device 410 in the retracted position can protrude or extend only slightly beyond the contour of the fuselage 101. In some embodiments, in the retracted position, the SPRO board 412 can be flush with the bottom surface or belly 144 of the fuselage 101 and contact at least a portion of the bottom surface 144. In still other embodiments, a part or all of the tail strike device 10 can be disposed within the fuselage, similar to the way at least some landing gears are stowed with respect to an aircraft fuselage. The curved edges of the SPRO board 412 can, for example, form or fit into a fairing with the bottom surface 144 of the fuselage 101, which can minimize drag.

The tail strike device 410 can be maneuvered in a similar manner as the tail strike device 10, such as by way of one or more actuators, and can occur automatically, manually, or by some combination of the two. A detailed description of such actuator(s) is thus unnecessary.

### Additional Analysis of the Tail Strike Device 410

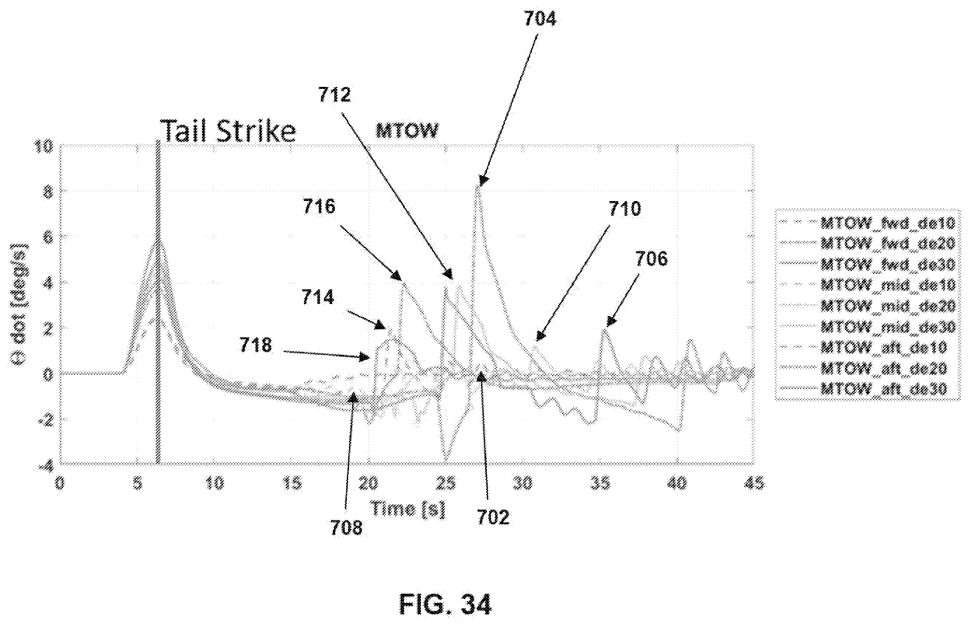

A study analyzing landing and takeoff performance at various mass configurations, center of gravity locations, and elevator deflection angles was used to derive an average rotational velocity about the airplane center of gravity during a tail strike impact. While the below analysis was performed with respect to the embodiment illustrated in FIGS. 28-32, its principles and teachings are applicable to other configurations provided for herein, including those illustrated in FIGS. 11-21B and FIGS. 22-23. As shown in FIG. 34, the rotational velocity at tail strike impact ranges from about 2 degrees per second to about 6 degrees per second. In the analysis a value of 4.5 degrees per second is used for sizing. In FIG. 34, line 702 represents MTOW_fwd_de10, line 704 represents MTOW_fwd_de20, line 706 represents MTOW_fwd_de30, line 708 represents MTOW_mid_de10, line 710 represents MTOW_mid_de20, line 712 represents MTOW_mid_de30, line 714 represents MTOW_aft_de10, line 716 represents MTOW_aft_de20, and line 718 represents MTOW_aft_de30.

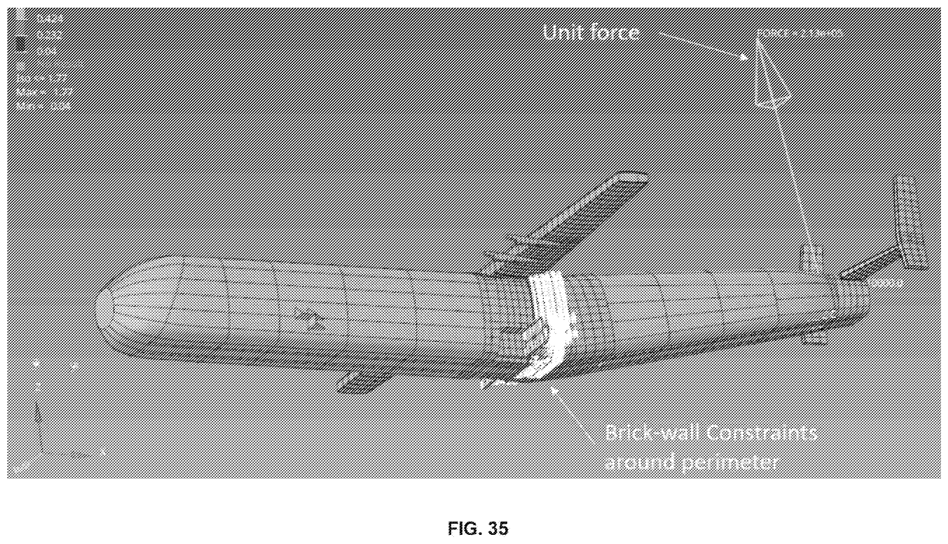

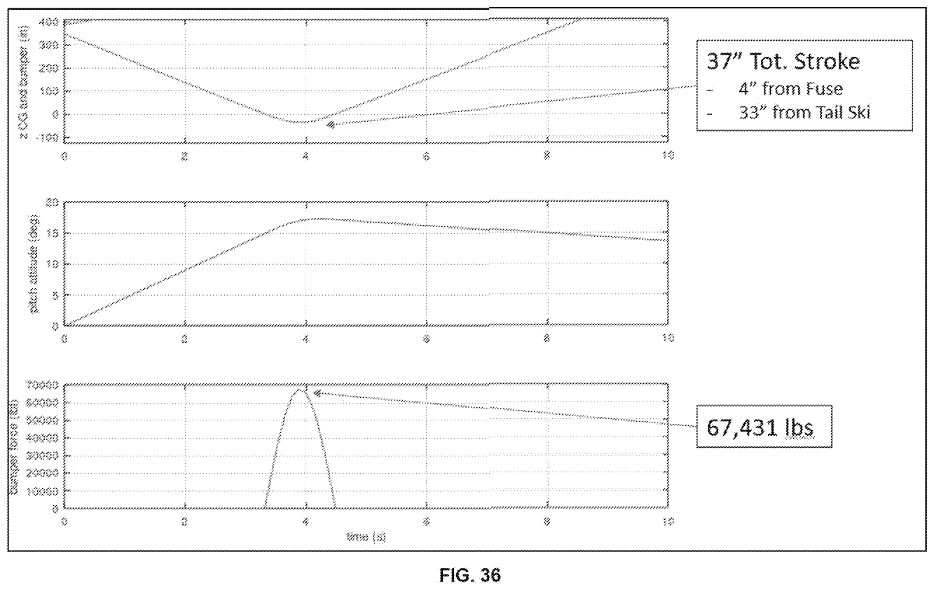

Next, a study was performed to determine the total force on the tail strike device 410 at impact with a runway. The total force is a function of both the tail strike device 410 stroke length and the aft fuselage stroke length, e.g., fuselage displacement parallel to the impact force vector. These two stroke lengths can be modeled as two springs in series. The aft fuselage airframe stiffness is known. Therefore, a spring stiffness value (K) can be derived using a linear approximation. Derived from a generalized finite element method (GFEM) model, as shown in FIG. 35, a linear static load case was setup with the aft fuselage brick-wall constrained around the fuselage perimeter near the airplane center of gravity. A unit force was then applied to the fuselage where the tail strike device 410 is located. The unit force applied divided by the total displacement results in a spring stiffness value for the aft fuselage (k_{fuse}) of approximately 20,000 pounds per inch (i.e., approximately 357,160 kilograms per meter). The following equation was used, F/d=k_{fuse}, where “F” is force, “d” is fuselage displacement (parallel to force vector), and k_{fuse} is the aft fuselage spring constant.

With the aft fuselage spring constant value established, a two (2) degrees of freedom simulation model (pitch rotation and vertical translation) was employed to calculate the force at the tail strike device 10 over a specified period of time. The spring constant of the tail strike device (k_{TS}) is an input. The resultant force at each time increment is a function of the equivalent spring constant and equivalent total stroke of both the fuselage and tail strike device in series, as captured in the equations below.
k_{eq}=Equivalent spring constant for the two systems in series
k_{TS}=Spring constant of the tail strike device
k_{fuse}=Spring constant of the aft fuselage
Fₜₒₜ=Total force from tail strike impact
X_{fuse}=Fuselage displacement (parallel to force vector)
X_{TS}=Fuselage displacement (parallel to force vector)

$${k}_{e q} = ( {k}_{fuse} * {k}_{TS} ) / ( {k}_{fuse} + {k}_{TS} )$$

$${F}_{t o t} = {k}_{eq} * ( {X}_{f u s e} + {X}_{TS} )$$

One goal in sizing the tail strike device 100 was to keep a total upwards (positive Z) shear load resulting from a tail strike impact within design limit loads. The limit flight load case resulting in the maximum upwards shear about the center of gravity from the aft fuselage is a −1 G Nz condition. The resulting shear on the airframe at the center of gravity is approximately 70,000 pounds. To avoid sizing global airframe panels based on the tail strike load case, the design goal for the tail strike device was to keep a total load under approximately 70,000 pounds. By varying the spring constant of the trail strike device (k_{TS}) to 2000 pounds per inch, a total tail strike device force of 67,431 pounds resulted. The graphs in FIG. 36 illustrate the results of the 2 degrees of freedom simulation results.

The impact surface 417 of the SPRO board 412 can be sized to exert pressure equal to or less than a maximum pressure exerted by nose or main landing gear tires under their most critical Nz load case, for example, a 3 Pt. Braked Roll. This maximum pressure constraint can be approximately 160 pounds per square inch. In one non-limiting embodiment, with a 70,000 pound tail strike load, this can result in a SPRO board impact surface area of approximately 434 in² (approximately 0.28 square meters). Using an aspect ratio of five, the contact area of the SPRO board can have dimensions of about 9.5 inches by about 47 inches (i.e., dimensions of about 24 centimeters to about 120 centimeters).

A maximum force on the crush can (Fcc, see FIG. 31) can be approximately 140,000 pounds. The majority of this load can be in the X-direction (Fcc*cos [10°]). This load can be sheared into the airframe, e.g., into a floor skin panel, over about 410 inches or two frame bays. The running load, which can be about 1,400 pounds per inch, falls within the design limit load envelope for the panel section. A maximum vertical pin reaction load (Fz) on the airframe supporting the aft swing arm (416) can be approximately 410,000 pounds. Subsequent frame mass to achieve a required frame section moment of inertia in the instant example is about 195 pounds, which can require only a minor additional structural mass to handle tail strike loads than already required by limit flight loads. Accordingly, tail strike devices 410 of the present disclosure can mitigate tail strike occurrences with limited additional structural mass to the fuselage 101.

Computer System for Use with or as Part of Tail Strike Mitigation Systems

FIG. 37 is a block diagram of one exemplary embodiment of a computer system 1200 upon which the present disclosures can be built, performed, trained, etc. For example, controllers that can be used to operate, monitor, and/or otherwise use the various tail strike devices disclosed herein can be of the nature of the system 1200 described herein such that the system 1200 can be involved in measuring, monitoring, and/or receiving various parameters and determining when and how to deploy one or more tail strike devices (e.g., the SPRO boards 12, 212, 412 and the airbag 340). By way of example, the system 1200, operating as a controller in conjunction with the present disclosures, can be operated to adjust the pitch angle of the tail skid during a takeoff and/or landing operation, allowing for a plurality of deployed, fixed positions to be achieved, as well as to move the tail skid into or out of the retracted position as well. The system 1200 can include a processor 1210, a memory 1220, a storage device 1230, and an input/output device 1240. Each of the components 1210, 1220, 1230, and 1240 can be interconnected, for example, using a system bus 1250. The processor 1210 can be capable of processing instructions for execution within the system 1200. The processor 1210 can be a single-threaded processor, a multi-threaded processor, or similar device. The processor 1210 can be capable of processing instructions stored in the memory 1220 or on the storage device 1230. The processor 1210 may execute operations such as moving the tail strike device to a desired position in anticipation of takeoff, landing, and/or a perceived tailstrike that may occur in conjunction with such operations, among other features described in conjunction with the present disclosure.

The memory 1220 can store information within the system 1200. In some implementations, the memory 1220 can be a computer-readable medium. The memory 1220 can, for example, be a volatile memory unit or a non-volatile memory unit. In some implementations, the memory 1220 can store information related to wind turbine blades and cargo bays, aircraft surroundings and environment data, among other information.

The storage device 1230 can be capable of providing mass storage for the system 1200. In some implementations, the storage device 1230 can be a non-transitory computer-readable medium. The storage device 1230 can include, for example, a hard disk device, an optical disk device, a solid-date drive, a flash drive, magnetic tape, and/or some other large capacity storage device. The storage device 1230 may alternatively be a cloud storage device, e.g., a logical storage device including multiple physical storage devices distributed on a network and accessed using a network. In some implementations, the information stored on the memory 1220 can also or instead be stored on the storage device 1230.

The input/output device 1240 can provide input/output operations for the system 1200. In some implementations, the input/output device 1240 can include one or more of network interface devices (e.g., an Ethernet card or an Infmiband interconnect), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 1240 can include driver devices configured to receive input data and send output data to other input/output devices, e.g., a keyboard, a printer, and/or display devices. In some implementations, mobile computing devices, mobile communication devices, and other devices can be used.

In some implementations, the system 1200 can be a microcontroller. A microcontroller is a device that contains multiple elements of a computer system in a single electronics package. For example, the single electronics package could contain the processor 1210, the memory 1220, the storage device 1230, and/or input/output devices 1240.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), or in an object-oriented programming language (e.g., “C++”). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink-wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud-computing model. Of course, some embodiments of the present disclosure may be implemented as a combination of both software (e.g., a computer program product) and hardware. Still other embodiments of the present disclosure are implemented as entirely hardware, or entirely software.

Examples of the above-described embodiments can include the following:
1. A tail strike mitigation system for an aircraft, comprising:
   a tail skid having an upper surface and a lower surface, the lower surface configured to contact a landing surface to prevent a fuselage of an aircraft from striking the landing surface; and
   a retraction system configured to couple the tail skid to an aft end of the fuselage of the aircraft located rearward of a landing gear of the aircraft,
   wherein the tail skid is sized such that a maximum pressure exerted by the tail skid on a landing surface is equal to or less than a pressure exerted by the landing gear of the aircraft on a landing surface in a case of maximum vertical load on the landing gear, and wherein the tail skid is sized so as to maximize distribution of a force imparted on the tail skid by the landing surface throughout the tail skid in an event of the tail skid contacting the landing surface.
2. The system of example 1, wherein the retraction system further comprises:
   a first linkage coupled to the tail skid at a first location;
   a second linkage coupled to the tail skid at a second location spaced apart from the first location; and
   an upper retraction assembly coupled to the tail skid, retained at least partially within the fuselage and configured to move the tail skid relative to the fuselage.
3. The system of example 2, wherein the upper retraction assembly includes a first linkage assembly and a second linkage assembly coupled to the first linkage assembly, and wherein the first linkage is coupled to the fuselage and the second linkage assembly is coupled to the tail skid.
4. The system of example 3, wherein the retraction system further comprises:
   an actuator coupled to the first linkage assembly
   wherein the actuator is configured to pull the first linkage assembly in a direction at least partially away from the bottom surface of the aft end of the fuselage to move the tail skid to the retracted position, and
   wherein the actuator is further configured to push the first linkage assembly in a direction at least partially toward the bottom surface to move the tail skid to the deployed position.
5. The system of example 3 or 4, wherein the second linkage assembly comprises a compressible member configured to compress linearly along a longitudinal axis of the compressible member from forces imparted on the tail skid upon contact with the landing surface.
6. The system of example 5, wherein an amount of compression of the compressible member is configured to correlate to a magnitude of impact of the tail skid and the landing surface.
7. The system of any of examples 1 to 6, wherein the tail skid is configured to be movable between a retracted position and a deployed position via the upper retraction assembly.
8. The system of example 7, wherein, in the deployed position, the tail skid is at a fixed location at a first distance from a bottom surface of the aft end of the fuselage at which the tail skid is configured to prevent the fuselage from contacting the landing surface in response to an attitude of the aircraft being one of equal to or exceeding a tail strike attitude at which the aft end will strike the landing surface.
9. The system of example 7 or 8, wherein the deployed position comprises a plurality of positions achievable by the tail skid, the plurality of positions having at least one of different pitch angles at which the tail skid is positioned with respect to at least one of the landing surface or the fuselage or different roll angles at which the tail skid is positioned with respect to at least one of the landing surface or the fuselage.
10. The system of any of examples 7 to 9, wherein, in the retracted position, the tail skid is located a second distance from a bottom surface of the aft end of the fuselage less than the first distance.
11. The system of any of examples 7 to 10, wherein, in the retracted position, the tail skid contacts the bottom surface of the aft end of the fuselage.
12. The system of any of examples 1 to 11, wherein the tail skid is configured to couple to the aft end of the fuselage of the aircraft at a location substantially underneath horizontal stabilizers of an empennage of the aircraft.
13. The system of any of examples 1 to 12, wherein a surface area of the lower surface of the tail skid is approximately 0.1 square meters or larger.
14. The system of example 13, wherein the surface area of the lower surface of the tail ski is approximately 0.29 square meters or larger.
15. The system of example 13, wherein the surface area of the lower surface of the tail skid is approximately in the range of about 0.1 square meters to about 1.0 square meters.
16. The system of example 15, wherein the surface area of the lower surface of the tail skid is approximately in the range of about 0.29 square meters to about 1.0 square meters.
17. The system of any of examples 1 to 16, wherein the lower surface of the tail skid has a generally rectangular shape.
18. The system of any of examples 1 to 17, wherein the tail skid comprises one or more curved edges that extend upwardly away from the lower surface.
19. The system of any of examples 1 to 18,
   wherein the tail skid comprises a composite sandwich panel,
   wherein a core material of the composite sandwich panel is formed of at least one of a honeycomb material, a wood material, or a foam material, and
   wherein opposed face sheets disposed on either side of the fore material are formed of at least one of a fiberglass material, an aramid material, or a carbon fiber material.
20. The system of any of examples 1 to 19, wherein the retraction system is configured to adjust at least one of a pitch angle of the tail skid with respect to at least one of the landing surface or the fuselage of the aircraft or a roll angle of the tail skid with respect to at least one of the landing surface or the fuselage of the aircraft to achieve a plurality of deployed, fixed positions for contacting a landing surface to minimize an impact on the aft end of the fuselage due to contacting the landing surface.
21. The system of example 20, further comprising:
   a controller configured to adjust at least one of the pitch angle of the tail skid or the roll angle of the tail skid during at least one of a takeoff operation or a landing operation to allow for the plurality of deployed, fixed positions.
22. The system of example 21, wherein the controller is configured to receive one or more data inputs and adjust at least one of the pitch angle or the roll angle in response to the same.
23. The system of example 22, wherein the controller is configured to adjust at least one of the pitch angle or the roll angle automatically in response to the one or more received data inputs.
24. A tail strike mitigation system for an aircraft, comprising:
   a tail skid having a lower surface configured to contact a landing surface to prevent a fuselage of an aircraft from striking the landing surface; and
   a retraction system configured to couple the tail skid to the fuselage of the aircraft, the linkage system including at least one adjustable actuating device configured to be able to adjust at least one of:
      a pitch angle of the tail skid relative to at least one of the landing surface or the fuselage to a desired first pitch angle such that a predetermined surface area of the lower surface of the tail skid is positioned to contact the landing surface at a desired pitch angle in an event of the tail skid contacting the landing surface; or
      a roll angle of the tail skid relative to at least one of the landing surface or the fuselage to a desired first roll angle such that a predetermined surface area of the lower surface of the tail skid is positioned to contact the landing surface at a desired roll angle in an event of the tail skid contacting the landing surface.
25. The system of example 24, wherein the retraction system further comprises:
   a first linkage coupled to the tail skid at a first location;
   a second linkage coupled to the tail skid at a second location spaced apart from the first location; and
   an upper retraction assembly coupled to the tail skid, retained at least partially within the fuselage and configured to move the tail skid relative to the fuselage.
26. The system of example 24 or 25, wherein the tail skid is configured to be movable between a retracted position and a deployed position via the upper retraction assembly, the deployed position comprising one or more fixed locations at which the tail skid is configured to be prevent the fuselage from contacting the landing surface in response to an attitude of the aircraft being one of equal to or exceeding a tail strike attitude at which the aft end will strike the landing surface.
27. The system of example 26, wherein the deployed position comprises a plurality of fixed locations at which the tail skid is configured to be prevent the fuselage from contacting the landing surface in response to an attitude of the aircraft being one of equal to or exceeding a tail strike attitude at which the aft end will strike the landing surface.
28. The system of example 26 or 27,
   wherein the tail skid defines a tail skid plane and a bottom surface of the aft end of the fuselage defines an aft fuselage plane,
   wherein the upper retraction assembly is configured to rotate the tail skid relative to the aft end of the fuselage, and
   wherein at least one of:
      a second pitch angle is defined between the tail skid plane and the aft fuselage plane and the first pitch angle is defined between the tail skid plane and the landing surface plane or
      a second roll angle is defined between the tail skid plane and the aft fuselage plane and the first roll angle is defined between the tail skid plane and the landing surface plane.
29. The system of any of example 28, wherein the retraction assembly is configured to rotate the tail skid such that the tail skid plane is substantially parallel with the aft fuselage plane.
30. The system of example 28 or 29, wherein the retraction assembly is configured to rotate the tail skid such that the tail skid plane is substantially parallel with the landing surface plane in response to the aircraft being oriented at a level attitude relative to a horizon.
31. The system of any of examples 28 to 30, wherein the retraction assembly is configured to rotate the tail skid such that the tail skid plane is substantially parallel with the landing surface plane in response to the aircraft being oriented at a first attitude relative to a horizon.
32. The system of any of examples 28 to 31, wherein the upper retraction assembly is configured to rotate the tail skid such that the first pitch angle is approximately in a range of about 0 degrees to about 25 degrees.
33. The system of any of examples 28 to 32, wherein the upper retraction assembly is configured to rotate the tail skid such that the second pitch angle is approximately in a range of about 0 degrees to about 25 degrees.
34. The system of any of examples 26 to 33, wherein, in the deployed position, the tail skid is at a fixed location a first distance from a bottom surface of the aft end of the fuselage at which the tail skid is configured to prevent the fuselage from contacting the landing surface in response to an attitude of the aircraft being one of equal to or exceeding a tail strike attitude at which the aft end will strike the landing surface.
35. The system of any of examples 26 to 34, wherein, in the retracted position, the tail skid is located a second distance from a bottom surface of the aft end of the fuselage less than the first distance.
36. The system of any of examples 26 to 35, wherein, in the retracted position, the tail skid contacts the bottom surface of the aft end of the fuselage.
37. The system of any of examples 24 to 36, wherein the tail skid is configured to couple to the aft end of the fuselage of the aircraft at a location substantially underneath horizontal stabilizers of an empennage of the aircraft.
38. The system of any of examples 24 to 37, wherein the lower surface of the tail skid has a generally planar lower surface portion surrounded by curved edges that extend upwardly away from the lower surface portion.
39. The system of any of examples 24 to 38, wherein a surface area of the lower surface of the tail skid is approximately 0.1 square meters or larger.
40. The system of example 39, wherein the surface area of the lower surface of the tail ski is approximately 0.29 square meters or larger.
41. The system of example 39, wherein the surface area of the lower surface of the tail skid is approximately in the range of about 0.1 square meters to about 1.0 square meters.
42. The system of example 41, wherein the surface area of the lower surface of the tail skid is approximately in the range of about 0.29 square meters to about 1.0 square meters.
43. The system of any of examples 24 to 42, wherein the lower surface of the tail skid has a generally rectangular shape.
44. The system of any of examples 24 to 43, wherein the tail skid comprises one or more curved edges that extend upwardly away from the lower surface.
45. The system of any of examples 24 to 44, wherein the tail skid comprises an upper layer defining the upper surface and a lower layer arranged underneath the upper layer and defining the lower surface, wherein the upper layer is formed of at least one of a honeycomb material, a wood material, or a foam material, and wherein the lower layer is formed of a composite material.
46. The system of any of examples 24 to 45, further comprising:
   a controller configured to adjust at least one of the pitch angle of the tail skid or the roll angle of the tail skid during at least one of a takeoff operation or a landing operation.
47. The system of example 46, wherein the controller is configured to receive one or more data inputs and adjust at least one of the pitch angle or the roll angle in response to the same.
48. The system of example 47, wherein the controller is configured to adjust at least one of the pitch angle or the roll angle automatically in response to the one or more received data inputs.
49. A method of one of landing an aircraft on a landing surface or taking an aircraft off from a landing surface, comprising:
   adjusting at least one of a pitch angle of a tail skid of an aircraft or a roll angle of a tail skid of an aircraft relative to at least one of a landing surface or a fuselage to a respective first pitch angle or first roll angle as the aircraft one of: (1) approaches the landing surface to land; or (2) readies to leave the landing surface to takeoff, the tail skid being adjustably coupled to an aft end of the aircraft located rearward of a landing gear of the aircraft, and the respective first pitch angle or first roll angle being an angle at which a predetermined surface area of a lower surface of the tail skid is configured to possibly contact the landing surface during respective landing or takeoff.
50. The method of example 49, wherein the tail skid includes an upper surface and a lower surface, the lower surface being configured to contact a landing surface to prevent a fuselage of the aircraft from striking the landing surface.
51. The method of example 49 or 50, further comprising:
   moving the tail skid from a retracted position to a deployed position.
52. The method of example 51, wherein, in the deployed position, the tail skid is located at a fixed location at a first distance from a bottom surface of the aft end of the fuselage, at which the tail skid is configured prevent the fuselage from contacting the landing surface in response to an attitude of the aircraft being one of equal to or exceeding a tail strike attitude at which the aft end will strike the landing surface.
53. The system of example 51 or 52, wherein the deployed position comprises a plurality of positions achievable by the tail skid, the plurality of positions having at least one of different pitch angles or different roll angles at which the tail skid is positioned with respect to at least one of the landing surface or the fuselage.
54. The method of any of examples 51 to 53, wherein, in the retracted position, the tail skid is located a second distance from a bottom surface of the aft end of the fuselage less than the first distance.
55. The method of any of examples 49 to 54,
   wherein the tail skid defines a tail skid plane and a bottom surface of the aft end of the fuselage defines an aft fuselage plane,
   wherein the landing surface defines a landing surface plane,
   wherein at least one of a second pitch angle or a second roll angle is defined between the tail skid plane and the aft fuselage plane and the respective first pitch angle or first roll angle is defined between the tail skid plane and the landing surface plane, and
   wherein the method further comprises rotating the tail skid relative to the aft end of the fuselage.
56. The method of example 55, further comprising:
   rotating the tail skid such that the tail skid plane is substantially parallel with the aft fuselage plane.
57. The method of example 55 or 56, further comprising:
   rotating the tail skid such that the tail skid plane is substantially parallel with the landing surface plane in response to the aircraft being oriented at a level attitude relative to a horizon.
58. The method of any of examples 55 to 57, further comprising:
   rotating the tail skid such that the tail skid plane is substantially parallel with the landing surface plane in response to the aircraft being oriented at a first attitude relative to a horizon.
59. The method of any of examples 49 to 58, wherein the tail skid is rotated such that the first pitch angle is approximately in a range of about 0 degrees to about 25 degrees.
60. The method of any of examples 49 to 59, wherein the tail skid is rotated such that the second pitch angle is approximately in a range of about 0 degrees to about 25 degrees.
61. The method of any of examples 49 to 60, wherein the tail skid is rotated such that the first roll angle is approximately in a range of about 0 degrees to about 25 degrees.
62. The method of any of examples 49 to 61, wherein the tail skid is rotated such that the second roll angle is approximately in a range of about 0 degrees to about 25 degrees.
63. The method of any of examples 49 to 62, further comprising:
   rotating the tail skid such that a forward end of the tail skid is higher than an aft end of the tail skid relative to the landing surface during landing of the aircraft.
64. A method of one of landing an aircraft on a semi-prepared runway or taking an aircraft off from a semi-prepared runway, comprising:
   causing a tail strike device coupled to an aft end of an aircraft located rearward of a landing gear of the aircraft to contact an upper landing surface of a semi-prepared runway to prevent a fuselage of the aircraft from contacting the upper landing surface of the semi-prepared runway while one of: (1) landing the aircraft; or (2) operating the aircraft to takeoff, the semi-prepared runway including a runway base layer beneath the upper landing surface,
   wherein, throughout the respective landing or takeoff, the tail strike device skims along the semi-prepared runway without penetrating past the upper landing surface and into the runway base layer.
65. The method of example 64, wherein the tail skid comprises an upper surface and a lower surface, the lower surface configured to contact the landing surface to prevent the fuselage of the aircraft from contacting the upper landing surface while the respective landing or takeoff of the aircraft.
66. The method of example 64 or 65, wherein tail skid is sized such that a maximum pressure exerted by the tail skid on the upper landing surface permits the tail skid along the upper landing surface while the respective landing or takeoff of the aircraft.
67. The method of any of examples 64 to 66, further comprising:
   moving the tail skid from a retracted position to a deployed position.
68. The method of example 67, wherein, in the deployed position, the tail skid is located at a fixed location at a first distance from a bottom surface of the aft end of the fuselage, at which the tail skid is configured to prevent the fuselage from contacting the landing surface in response to an attitude of the aircraft being one of equal to or exceeding a tail strike attitude at which the aft end will strike the landing surface.
69. The method of example 67 or 68, wherein the deployed position comprises a plurality of positions achievable by the tail skid, the plurality of positions having at least one of different pitch angles at which the tail skid is positioned with respect to at least one of the landing surface or the fuselage or different roll angles at which the tail skid is positioned with respect to at least one of the landing surface or the fuselage.
70. The method of any of examples 67 to 69, wherein, in the retracted position, the tail skid is located a second distance from a bottom surface of the aft end of the fuselage less than the first distance.
71. The method of any of examples 64 to 70,
   wherein the tail skid defines a tail skid plane and a bottom surface of the aft end of the fuselage defines an aft fuselage plane,
   wherein the landing surface defines a landing surface plane,
   wherein at least one of a second pitch angle or a second roll angle is defined between the tail skid plane and the aft fuselage plane and the respective first pitch angle or roll angle is defined between the tail skid plane and the landing surface plane, and
   wherein the method further comprises rotating the tail skid relative to the aft end of the fuselage.
72. The method of example 71, further comprising:
   rotating the tail skid such that the tail skid plane is substantially parallel with the aft fuselage plane.
73. The method of example 71 or 72, further comprising:
   rotating the tail skid such that the tail skid plane is substantially parallel with the landing surface plane in response to the aircraft being oriented at a level attitude relative to a horizon.
74. The method of any of examples 71 to 73, further comprising:
   rotating the tail skid such that the tail skid plane is substantially parallel with the landing surface plane in response to the aircraft being oriented at a first attitude relative to a horizon.
75. The method of any of examples 64 to 74, wherein the tail skid is rotated such that the first pitch angle is approximately in a range of about 0 degrees to about 25 degrees.
76. The method of any of examples 64 to 75, wherein the tail skid is rotated such that the second pitch angle is approximately in a range of about 0 degrees to about 25 degrees.
77. The method of any of examples 64 to 76, further comprising:
   rotating the tail skid such that a forward end of the tail skid is higher than an aft end of the tail skid relative to the landing surface during landing of the aircraft.

One skilled in the art will appreciate further features and advantages of the disclosure based on the above-described embodiments. Accordingly, the disclosure is not to be limited by what has been particularly shown and described, except as indicated by the appended claims. By way of non-limiting example, although the tail strike devices and methods disclosed herein are described in connection with a takeoff or landing operation on a semi-prepared runway, the present disclosure can also be applicable to takeoff or landing operations on a fully prepared or typical commercial runway. Further, while the tail strike devices and methods described above include a single tail strike device utilized with a single aircraft, in some embodiments a plurality of tail strike devices can be utilized with a single aircraft to mitigate tail strike events. All publications and references cited herein are expressly incorporated herein by reference in their entirety.

1. A tail strike mitigation system for an aircraft, comprising:
a tail skid having an upper surface and a lower surface, the lower surface configured to contact a landing surface to prevent a fuselage of an aircraft from striking the landing surface; and
a retraction system configured to couple the tail skid to an aft end of the fuselage of the aircraft located rearward of a landing gear of the aircraft,
wherein the tail skid is sized such that a maximum pressure exerted by the tail skid on a landing surface is equal to or less than a pressure exerted by the landing gear of the aircraft on a landing surface in a case of maximum vertical load on the landing gear, and
wherein the tail skid is sized so as to maximize distribution of a force imparted on the tail skid by the landing surface throughout the tail skid in an event of the tail skid contacting the landing surface.

2. The system of claim 1, wherein the retraction system further comprises:
a first linkage coupled to the tail skid at a first location;
a second linkage coupled to the tail skid at a second location spaced apart from the first location; and
an upper retraction assembly coupled to the tail skid, retained at least partially within the fuselage and configured to move the tail skid relative to the fuselage.

3. The system of claim 2, wherein the upper retraction assembly includes a first linkage assembly and a second linkage assembly coupled to the first linkage assembly, and wherein the first linkage is coupled to the fuselage and the second linkage assembly is coupled to the tail skid.

4. The system of claim 3, wherein the retraction system further comprises:
an actuator coupled to the first linkage assembly
wherein the actuator is configured to pull the first linkage assembly in a direction at least partially away from the bottom surface of the aft end of the fuselage to move the tail skid to the retracted position, and
wherein the actuator is further configured to push the first linkage assembly in a direction at least partially toward the bottom surface to move the tail skid to the deployed position.

5. The system of claim 3, wherein the second linkage assembly comprises a compressible member configured to compress linearly along a longitudinal axis of the compressible member from forces imparted on the tail skid upon contact with the landing surface.

6. The system of claim 5, wherein an amount of compression of the compressible member is configured to correlate to a magnitude of impact of the tail skid and the landing surface.

7. The system of claim 1, wherein the tail skid is configured to be movable between a retracted position and a deployed position via the upper retraction assembly.

8. The system of claim 7, wherein, in the deployed position, the tail skid is at a fixed location at a first distance from a bottom surface of the aft end of the fuselage at which the tail skid is configured to prevent the fuselage from contacting the landing surface in response to an attitude of the aircraft being one of equal to or exceeding a tail strike attitude at which the aft end will strike the landing surface.

9. The system of claim 7, wherein the deployed position comprises a plurality of positions achievable by the tail skid, the plurality of positions having at least one of different pitch angles at which the tail skid is positioned with respect to at least one of the landing surface or the fuselage or different roll angles at which the tail skid is positioned with respect to at least one of the landing surface or the fuselage.

10. The system of claim 7, wherein, in the retracted position, the tail skid is located a second distance from a bottom surface of the aft end of the fuselage less than the first distance.

11. The system of claim 7, wherein, in the retracted position, the tail skid contacts the bottom surface of the aft end of the fuselage.

12. The system of claim 1, wherein the tail skid is configured to couple to the aft end of the fuselage of the aircraft at a location substantially underneath horizontal stabilizers of an empennage of the aircraft.

13. The system of claim 1, wherein a surface area of the lower surface of the tail skid is approximately 0.1 square meters or larger.

14. The system of claim 13, wherein the surface area of the lower surface of the tail ski is approximately 0.29 square meters or larger.

15. The system of claim 13, wherein the surface area of the lower surface of the tail skid is approximately in the range of about 0.1 square meters to about 1.0 square meters.

16. The system of claim 15, wherein the surface area of the lower surface of the tail skid is approximately in the range of about 0.29 square meters to about 1.0 square meters.

17. (canceled)

18. The system of claim 1, wherein the tail skid comprises one or more curved edges that extend upwardly away from the lower surface.

19. The system of claim 1,
wherein the tail skid comprises a composite sandwich panel,
wherein a core material of the composite sandwich panel is formed of at least one of a honeycomb material, a wood material, or a foam material, and
wherein opposed face sheets disposed on either side of the fore material are formed of at least one of a fiberglass material, an aramid material, or a carbon fiber material.

20. The system of claim 1,
wherein the retraction system is configured to adjust at least one of a pitch angle of the tail skid with respect to at least one of the landing surface or the fuselage of the aircraft or a roll angle of the tail skid with respect to at least one of the landing surface or the fuselage of the aircraft to achieve a plurality of deployed, fixed positions for contacting a landing surface to minimize an impact on the aft end of the fuselage due to contacting the landing surface.

21. The system of claim 20, further comprising:
a controller configured to adjust at least one of the pitch angle of the tail skid or the roll angle of the tail skid during at least one of a takeoff operation or a landing operation to allow for the plurality of deployed, fixed positions.

22. The system of claim 21, wherein the controller is configured to receive one or more data inputs and adjust at least one of the pitch angle or the roll angle in response to the same.

23. The system of claim 22, wherein the controller is configured to adjust at least one of the pitch angle or the roll angle automatically in response to the one or more received data inputs.

24. A tail strike mitigation system for an aircraft, comprising:
a tail skid having a lower surface configured to contact a landing surface to prevent a fuselage of an aircraft from striking the landing surface; and
a retraction system configured to couple the tail skid to the fuselage of the aircraft, the linkage system including at least one adjustable actuating device configured to be able to adjust at least one of:
a pitch angle of the tail skid relative to at least one of the landing surface or the fuselage to a desired first pitch angle such that a predetermined surface area of the lower surface of the tail skid is positioned to contact the landing surface at a desired pitch angle in an event of the tail skid contacting the landing surface; or
a roll angle of the tail skid relative to at least one of the landing surface or the fuselage to a desired first roll angle such that a predetermined surface area of the lower surface of the tail skid is positioned to contact the landing surface at a desired roll angle in an event of the tail skid contacting the landing surface.

25-48. (canceled)

49. A method of one of landing an aircraft on a landing surface or taking an aircraft off from a landing surface, comprising:
adjusting at least one of a pitch angle of a tail skid of an aircraft or a roll angle of a tail skid of an aircraft relative to at least one of a landing surface or a fuselage to a respective first pitch angle or first roll angle as the aircraft one of: (1) approaches the landing surface to land; or (2) readies to leave the landing surface to takeoff, the tail skid being adjustably coupled to an aft end of the aircraft located rearward of a landing gear of the aircraft, and the respective first pitch angle or first roll angle being an angle at which a predetermined surface area of a lower surface of the tail skid is configured to possibly contact the landing surface during respective landing or takeoff.

50-77. (canceled)
